(19) United States
(12) Patent Application Publication
(10) Pub. No.: US 2019/0122448 A1
(43) Pub. Date: Apr. 25, 2019

(54) VEHICLE PARKING SYSTEM AND METHOD

(71) Applicant: PREMIER PARKING LLC, DENVER, CO (US)

(72) Inventor: Constance M. Volz, Arvada, CO (US)

(21) Appl. No.: 16/014,668

(22) Filed: Jun. 21, 2018

Related U.S. Application Data
(63) Continuation of application No. 15/489,135, filed on Apr. 17, 2017, now abandoned.
Application No. 15/489,135 is a continuation of application No. 13/601,418, filed on Aug. 31, 2012, now abandoned.
Application No. 13/601,418 is a continuation-in-part of application No. 13/426,742, filed on Mar. 22, 2012, now abandoned.
Application No. 13/426,742 is a continuation-in-part of application No. 13/071,128, filed on Mar. 24, 2011, now abandoned.

(51) Int. Cl. G07B 15/02; G07B 15/06; G06Q 30/02; G06Q 30/06

(52) U.S. Cl. CPC G07B 15/02; G07B 15/063; G06Q 30/0266; G06Q 30/0645; G06Q 30/0631; G06Q 30/0258

(57) ABSTRACT

Profiles may be used to define various entities involved in management of parking facilities. Profiles may be defined for: parking facilities, users of parking facilities, owners of parking facilities, locations of tenants of buildings, management companies of buildings, etc. Links may be established between the various profiles to define relationships. Based on the links between profiles, parking rights and management of the parking facilities may be controlled.

### CROSS REFERENCES

This application is a continuation-in-part of U.S. patent application Ser. No. 13/426,742, filed Mar. 22, 2012, entitled “Parking Management Systems and Method,” attorney docket number 028706-000110US (93167-833119), which is a continuation-in-part of U.S. patent application Ser. No. 13/071,128, filed Mar. 24, 2011, entitled “Parking Management Systems and Method, attorney docket number 028706-000100US (93167-798904). The entire disclosures of which is hereby incorporated for all purposes.

### BACKGROUND

Parking a vehicle, especially in urban areas, can be time consuming and stressful. Two scenarios are typical: a vehicle that is parked in the same parking facility often (e.g., a vehicle parked by a person who works in an office building near the parking facility); and a vehicle that is parked infrequently or only once in a parking facility (e.g., a vehicle parked by a person to run an errand, visit a restaurant, or attend a sporting event in the vicinity of the parking facility). Each of these scenarios may result in various inefficiencies. The person parking the vehicle frequently may have a leased parking space that periodically, such as on nights, vacations, weekends, and holidays, remains vacant. The person parking the vehicle infrequently may have difficulty finding a parking facility with available parking spaces and/or finding a parking facility with acceptable parking rates.

### SUMMARY

Various arrangements are present for managing one or more parking facilities. Methods, systems, and computer program products are presented for managing one or more parking facilities. A first profile for a parking facility that defines characteristics of the parking facility may be created. The characteristics of the parking facility may comprise: an address of the parking facility, a number of parking spaces of the parking facility, and a type of the parking facility. A second profile may be created for an owner of the parking facility that defines characteristics of the owner. The characteristics of the owner may comprise a name of the owner and an address for the owner. Input may be received that indicates to link the owner to the parking facility using the first profile and the second profile. The owner may be linked to the parking facility using the first profile and the second profile. The second profile may be available to be linked with profiles of additional parking facilities.

Arrangements may include one or more of the following: A report about multiple parking facilities may be created. The multiple parking facilities comprise the parking facility. A profile for each of the multiple parking facilities may linked with the owner. The report may indicate usage data of the multiple parking facilities. A third profile may be created for a tenant location linked with multiple tenants that defines characteristics of the location, the characteristics of the location comprising a tenant location name, and a tenant location address, wherein the multiple tenants are to be associated with a parking facility. Input may be received that indicates to link the tenant location to the parking facility using the first profile and the third profile. The parking facility may be linked to the tenant location using the first profile and the third profile. Access may be provided to the parking facility for the multiple tenants associated with the tenant location at least partially based on the first profile and the third profile being linked. Input may be received selecting the first profile of the parking facility. Input may be received that indicates a parking space is to be added to the first profile of the parking facility, the input comprising: a location within the parking facility where the parking space is located, and a classification of the parking space. The first profile of the parking facility may be modified to comprise the parking space.

The usage data of the report may comprise data for the multiple parking facilities on reserved parking and non-reserved parking. A third profile may be created for a group parking account that defines characteristics of the group parking account. The characteristics of the group parking account may comprise a group name, contact information for the group, and a number of parking spaces allocated to the group parking account. Input may be received that indicates to link a user with the group parking account using the third profile and a user profile of the user. The group parking account may be linked to the user using the third profile and the user profile. A parking space of the parking spaces allocated to the group parking account may be assigned to the user profile and user. A third profile may be created for a management entity that defines characteristics of the management entity, the characteristics of the management entity comprising a name of the management entity, an address of the management entity, and contact information for a representative of the management entity. Input may be received that indicates to link the management entity to the tenant location using the third profile and second profile. The management entity may be linked to the tenant location using the third profile and the second profile.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a parking management system.

FIG. 2 illustrates another embodiment of a parking management system.

FIG. 3 illustrates an embodiment of a parking facility management dashboard.

FIG. 4 illustrates an embodiment of a parking system graphical user interface.

FIG. 5 illustrates another embodiment of a parking system graphical user interface.

FIG. 6 illustrates another embodiment of a parking system graphical user interface.

FIG. 7 illustrates an embodiment of a parking system graphical user interface.

FIG. 8 illustrates an embodiment of a parking facility access system.

FIG. 9 illustrates an embodiment of a method for creating a user account for a parking management system.

FIG. 10 illustrates an embodiment of a method for permitting use of a parking facility without requiring payment to be provided at the parking facility.

FIG. 11 illustrates an embodiment of a method for remotely reserving a parking space for a user.

FIG. 12 illustrates an embodiment of providing users in a queue the opportunity to acquire a parking space.

FIG. 13 illustrates an embodiment of a graphical user interface that may permit a customer to select a parking space (or type of parking space) for day use or lease.

FIG. 14 illustrates an embodiment of a method for offering vehicle parking.

FIG. 15 illustrates another embodiment of a method for offering vehicle parking.

FIG. 16 illustrates an embodiment of a method for managing a parking facility using parking facility and owner profiles.

FIG. 17 illustrates an embodiment of a method for managing a parking facility using parking facility, user, and group account profiles.

FIG. 18 illustrates an embodiment of a method for managing a parking facility using tenant location and management entity profiles.

FIG. 19 illustrates an embodiment of a graphical user interface for interacting with profiles.

FIG. 20 illustrates an embodiment of a computer system.

### DETAILED DESCRIPTION

A computerized parking management system that allows entities, such as parking facility managers, (e.g., the person, company, or other entity that owns and/or manages the parking facility), parking space lessees, day users, and group lessees to manage the use of parking spaces within one or more parking facilities may allow for more efficient and more cost effective parking facility management. Real time or near real time accessibility of parking inventory may increase utilization of parking spaces and provide customers with the ability to view and select parking spaces which normally would not be accessible or would be difficult to find by the customer at a reasonable rate.

A computerized parking system may allow transactions that are typically performed at a parking facility to be either fully or partially completed remotely, such as via a web based interface. The use of such a remote interface may allow for functions, such as payment, parking space allocation, and/or leasing to be handled at a more convenient location and/or time. As such, the amount of time spent entering and/or exiting a parking facility may be decreased by not requiring a user (who is likely operating a vehicle) to render payment at either the time of entrance or exit from the parking facility. Speeding the entry and exit times to a parking facility may decrease the length of time vehicles spend idling. Further, a need for staffing at the parking facility may be decreased or eliminated. Moreover, tickets may not need to be issued to some or all users, thus decreasing the amount of paper and/or ink used. “Passback,” the use of one access device to let multiple vehicles into a parking facility, may also be decreased by using such a computerized parking system.

Using a computerized parking system may allow for a day user (a person who uses the parking facility once or more but does not have a rented, leased, or owned parking space within the parking facility) to park more efficiently. In some embodiments, such as via the web interface, a day user can reserve a parking space at a parking facility before physically arriving at the parking facility. As such, the day user may be assured that a parking space is available for the day user's vehicle upon arrival. Further, the day user may be permitted to reserve a parking space in a specific region of the parking facility possibly resulting in an adjustment of cost. For example, a reserved parking space near the entrance of the parking facility may cost more than a rooftop parking space. In some embodiments, a day user may be permitted to select a specific parking space.

A day user may also be presented with a listing and/or map of multiple parking facilities available through the computerized parking management system in a requested geographic area. From the list or map, the day user may select which parking facility the day user desires to use. The parking facilities may have varying cost structures. If a day user selects a parking facility that does not have space available, the day user may be directed to the next closest parking facility managed through the computerized parking management system.

Further, a day user (or lessee) may have their vehicle matched to parking space dimensions. For example, if a user specifies that their vehicle is long vehicle (e.g., an extended cab pickup truck), the size of the vehicle may be taken into account when locating an appropriate parking space. As such, parking space dimensions, garage clearance, and/or mobility of a vehicle (e.g., turning radius) may be used to identify which parking facilities or portions of parking facilities are accessible to the user's vehicle and/or which parking spaces within the parking facility are appropriate to use.

A computerized parking management system may allow the parking facility manager (herein referred to as “manager,” e.g., the person, company, or other entity that owns and/or manages the parking facility) to operate the parking facility more efficiently. The manager may be provided with a dashboard that displays real time utilization information about the parking facility. The dashboard may provide the manager with the ability to view information such as: information on leased parking spaces, number of day users, sell factors, turn factors, distribution of use by day users throughout the day, and the number of hours typically parked within parking facility. A dashboard report may be sent periodically to the manager in the form of a scheduled dashboard report. For example, via email once per day or week, a manager may receive a dashboard report with information related to utilization of one or more parking facilities linked with the manager.

Further, the manager may be able to electronically vary the rates for the parking facility by manipulating the rates presented to day users via the web interface and/or displayed electronically at the parking facility. For example, in anticipation of a large event in the vicinity of the parking facility, such as a parade, parking rates may be increased. The manager may also allow advertisements to be displayed at the parking facility. Based on the users of the parking facility, these advertisements may be adjusted to target specific users as they enter and/or exit the parking facility. These advertisements may also be based on the time of day, day of week, and/or other characteristics of the user parking in the parking facility. For example, a user parking in the facility at night or the weekend may be displayed advertisements for restaurants and movie theatres in the area, while a user parking during the day on a weekday may be displayed advertisements directed to business-oriented services.

A computerized parking management system may also allow the parking facility manager to increase the utilization of the parking facility, and thus, possibly increase profit margins. For example, the parking facility manager may be able to employ an oversell factor. The computerized parking management system may provide a manager with the ability to “lease back” parking spaces from lessees (who lease, rent, own, or otherwise hold the rights to a parking space within the parking facility). As an example, if a nighttime sporting event is occurring near the parking facility, many spaces leased by professionals who work in the area during the day may typically remain vacant. The computerized parking management system may provide the manager with the ability to provide these lessees with an offer to lease back a parking space for a period of time (such as an amount of money for the time period of the sporting event). As such, if the lessee accepts the offer, the lessee would gain the consideration of the offer and the manager would gain the ability to sell another parking space (presumably for more money than the offer) for during the sporting event. As another example, the computerized parking management system may track which parking facilities in the network have higher oversell factors on certain days of the week (“garage full” status). Such parking facilities may contract with other parking facilities and could charge a redirection fee for their customers to the receiving facility. This allows the oversell factor to be based on the oversell factor averages of the parking facility and not on one or two days of above average volume which may be due to area events or business meetings/training scheduled in the building or area. The parking management system may grant a first parking facility validation parking privileges for their guests at a second parking facility if the customer is redirected.

A computerized parking management system may also provide building tenants with efficient parking opportunities. A tenant (e.g., a corporation, company, or other entity that frequently requires parking spaces within the parking facility) may validate parking for guests parked in a parking facility in the vicinity of the tenant. Typically, this involves providing the guest with a coupon, stamp, or other physical evidence of validation that needs to be produced upon exit from the parking facility. The building tenant may instead provide the computerized parking management system with a vehicle identifier (such as a license plate number) of the guest's vehicle. Upon attempting to exit the parking facility, the guest may be granted egress without any further interaction with the parking access system of the parking facility by the guest.

A computerized parking management system may also provide a group tenant that leases a group of parking spaces (via a group account) with efficient parking management opportunities. The group tenant may, such as through a web interface, manage which users and/or vehicles are permitted access to the parking facility and/or parking spaces linked with the tenant. For example, an employee that is terminated may be immediately blocked from entering the parking facility by the group tenant by using a web interface.

A computerized parking management system may also provide potential lessees an efficient interface to queue for an available parking space. As parking spaces become available for lease, the computerized parking management system may automatically contact previously-identified potential lessees present in a queue. The space may then be allocated to one of the potential lessees based on offers and responses, possibly exchanged via text message.

A parking management system may involve the use of profiles. Profiles may be configured for parking facilities, buildings, parking management entities, parking facility owners, group (e.g., corporate) accounts, users (e.g., day users or lessees), and/or groups of tenants (e.g., all tenants with offices in a particular building). Each profile may contain information specific to the type of entity. For example, a profile for a parking facility may contain different data fields than a profile directed to a group of tenants. Such profiles may be linked with each other to identify relationships between profiles. As an example, a profile for a parking facility may be linked with an owner's profile. This may identify the owner as the owner of the parking facility. Further, such linking may be used to provide the owner with certain information regarding the parking facility. For example, if the owner is linked with multiple parking facilities, a report may be generated that usage data across all of the parking facilities linked with the owner. If the parking facility is sold by the owner, the parking facility profile may be linked with a profile of the new owner.

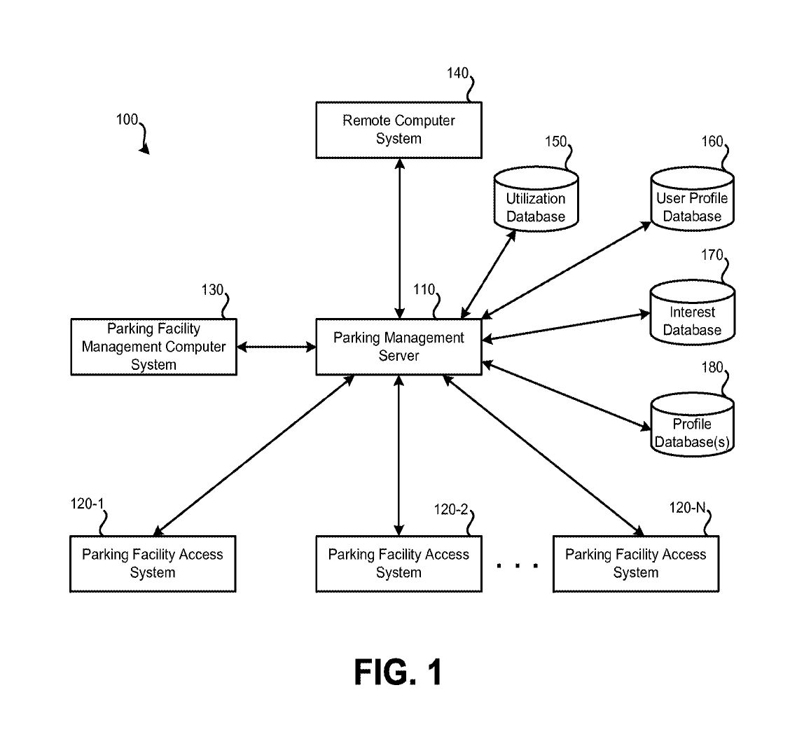

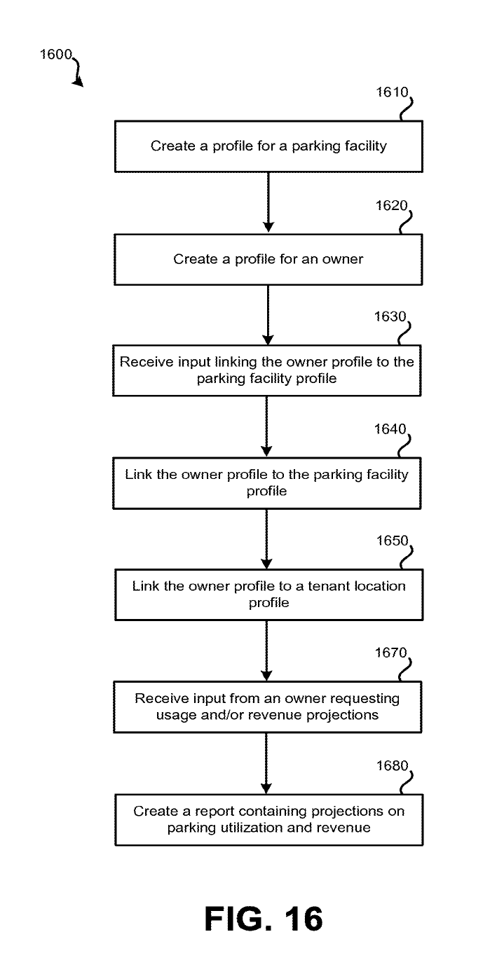

FIG. 1 illustrates an embodiment of parking management system 100. Parking management system 100 may include: parking management server 110, parking facility access systems 120, parking facility management computer system 130, and remote computer system 140. Each of these components may include a computer system, such as computer system 1600 of FIG. 16. Parking management system 100 may be used to manage parking at one or more parking facilities.

A parking facility may be any type of parking area where a vehicle is permitted to park. A fee may be required to be paid for use of the parking facility according to some time period (such as per hour, per day, or per month). Access to a parking facility may be controlled such that only vehicles that have paid, have billing information on file, or are expected to pay, are allowed entrance to and/or egress from the parking facility. Parking facilities include parking garages (e.g., an airport parking garage, a parking garage within an office building, a stand alone parking garage) and surface lots, and/or combinations thereof. Other forms of parking facilities may also be possible.

Parking management server 110 may represent a computer system that is in communication with parking facility access systems 120, which are located at one or more parking facilities. Parking management server 110 may be operated by the same entity that owners and/or manages some or all of these parking facilities. In some embodiments, parking management server 110 is operated by a third-party entity, such as by an entity that contracts with parking facility owners and/or managers to handle billing, leasing, and general access to the parking facility.

Parking management server 110 may communicate with one or more parking facility access systems, such as parking facility access systems 120. Parking facility access system 120-1 may be located at one parking facility while parking facility access system 120-2 is located at another parking facility geographically separated from parking facility access system 120-1. As such, parking facility access systems 120-1 and 120-2 may be located at parking facilities that are within the same city or are separated by significant distances, such as parking facilities located on opposite coasts. Parking facility access system 120-N represents that parking management server 110 may be in communication with a varying number of parking facility access systems. While three parking facility access systems 120 are illustrated as part of parking management system 100 in the illustrated embodiment, it should be understood that one, two, four, or more parking facility access systems may be in communication with parking management server 110 in other embodiments.

Parking management server 110 may exchange information with each of parking facility access systems 120. When a vehicle attempts to enter and/or exit from a parking facility, an associated parking facility access system, such as parking facility access system 120-1, may transmit information to parking management server 110. Parking facility access system 120-1 may transmit a vehicle identifier that serves to identify the vehicle to parking management server 110. Based upon a response from parking management server 110, parking facility access system 120-1 may perform actions such as: permit entrance to the parking facility, deny access to the parking facility, require payment before entrance to the parking facility, require payment before exit from the parking facility, allow entrance and/or exit without payment being made at the parking facility, and/or display advertisements directed to the user.

When a vehicle enters and/or exits from a parking facility, such as the parking facility associated with parking facility access systems 120-1, various information may be updated at parking management server 110. For example, parking management server 110 may be in communication with one or more databases, such as utilization database 150 and user profile database 160. Utilization database 150 may be used to store information regarding the current and past utilization of the parking facilities associated with parking facility access systems 120. Utilization database 150 may also store information regarding patterns and trends related to one or more parking facilities. When a vehicle enters and/or exits the parking facility associated with parking facility access system 120-1, utilization database 150 may be updated to reflect the activity by the vehicle. User profile database 160 may be used to store information regarding users that have accounts with parking management server 110. Each user may have a user profile that contains information about the user and the user's vehicles. The user's profile may be linked with various parking facility profiles, group account profiles, and other types of profiles detailed herein. When a user attempts to access a parking facility, the corresponding parking facility access system may transmit a vehicle identifier to parking management server 110. Parking management server 110 may then determine whether the vehicle identifier matches a vehicle linked with a user having a record in user profile database 160. Based upon the result, parking management server 110 may respond to the parking facility access system with instructions indicating how to handle the user and her associated vehicle.

A vehicle identifier may be an identifier that is sufficient to distinguish a vehicle from other vehicles. One possible vehicle identifier can include a license plate number. The license plate number may be used in conjunction with other license plate information, such as the name of the state (or other governmental institution) that issued the license plate. Use of the license plate as the vehicle identifier has an advantage that no additional hardware may need to be installed on the vehicle. Other forms of vehicle identifiers can include RFID. Use of RFID may require that a user install an RFID tag on the vehicle. Still other forms of vehicle identifiers may be used, for example a wireless platform with receivers mounted in a parking facility may receive position information from wireless sensors present on vehicles. Such an arrangement may be useful in not only determining the vehicle entering and exiting a parking facility, but where in the parking facility the vehicle has parked and has driven. For example, based on the location of the sensor, it may be determined what parking space a vehicle is in. In some embodiments, GPS may be used to determine the location of a vehicle.

One or more profile databases may be present, represented as profile database(s) 180. In addition to a profile database being preset for users, a profile database may be present for parking facilities, group accounts, tenant locations (e.g., office buildings), management companies, parking facility owners, etc. Each profile may store information about the entity it describes. The available fields within each profile may vary based on the type of profile. Links between such profiles may be indicated by a manager and stored. Such links may indicate relationships between the entities represented by the profiles. For instance, if a parking facility profile is linked with an owner profile, this may indicate the owner owns the parking facility. If the owner also owns another parking facility that is managed using the parking management server, the same profile of the owner may be linked with the profile of the additional parking facility. If ownership of a parking facility changes, a different owner profile may be assigned to the parking facility. Links between profiles may also be used to indicate parking privileges. For example, if a user profile is linked to a group account, the user may be permitted to park in at least some of the parking facilities associated with the group account.

If a user profile is linked with a group account, the user may be permitted to utilize lease rates and/or discounts in at least some of the parking facilities associated with the group account. A user account may be used in conjunction with both personal and business parking. For instance, a user profile may be linked with a group account for a parking space associated with the user's job. The user account may be used when the user is parking for personal use. Accordingly, some expenses, such as the cost of the leased parking space, may be covered via the group account, while other costs may be covered by the user providing payment. Some expenses related to parking may be divided between a group account and the user. For example, if a user selects a parking space of greater value than a lease allocation available to the user via a group account, a split obligation may be assigned between the user account and the group account. In such embodiments, the group account may pay a portion of the cost for the leased space, with the user paying the remainder. As an example of this, a business may provide a group account that permits employees $200 per month to park in a particular parking facility. The user may select to lease a parking space that costs $275 per month. In such an example, the group account may be charged $200 per month, and the user's account may be charged $75 per month, thus dividing the cost between the business and the user. Various features of the types of profiles and uses of such profiles are further detailed in reference to FIGS. 16 through 18.

Parking management server 110 may be in communication with parking facility management computer system 130. Parking facility management computer system 130 may be operated by a manager of one or more parking facilities. While only one parking facility management computer system 130 is illustrated as part of parking management system 100, it should be understood that one or more additional parking facility manager computer systems may communicate with parking management server 110, such as a parking facility manager computer system for each parking facility that has an associated parking facility access system in communication with parking management server 110. Users may be granted parking access to multiple parking facilities in communication with parking management server 110. For example, a user may have a monthly rate to use multiple parking facilities. For example, consider a sales executive that regularly uses multiple parking facilities throughout a metro area. The executive may be able to get a monthly fee that covers parking in multiple parking facilities in communication with parking management server 110. Such a user may select a “home” garage, but may receive a favorable rate at other facilities linked with parking management server 110.

Parking facility management computer system 130 may present a parking facility manager with a dashboard displaying information about the parking facility associated with the parking facility manager computer system. The dashboard may be a software application executed by parking facility management computer system 130 that receives information from parking management server 110. In some embodiments, the dashboard is a web-based application, which may be accessible by parking facility management computer system 130 via a web browser. The information displayed by the dashboard may be in real-time (e.g., current within the past minute or hour) or near real-time (e.g., current within the previous day). The information displayed by the dashboard at parking facility management computer system 130 may include information such as the utilization of the parking facility, the status of parking space leases, the rate structure, and use by day users. The parking facility manager may elect to receive the dashboard reports at specific dates and times. This may be set up through a report scheduler accessible via the parking facility manager computer system.

Parking facility management computer system 130 may permit the manager to modify characteristics of the parking facility as stored by parking management server 110. For example, a manager may adjust the number of parking spaces available for day use and/or leases. The manager may also adjust the rate structure of the parking facility. If additional parking spaces are added to the parking facility (such as through a physical addition or parking space line repainting) the number of parking spaces may be adjusted at parking management server 110. Such additional spaces may include motorcycle, bicycle, and vehicle storage parking areas (e.g., for RV's). The parking facility manager may use this information to measure and/or calculate parking utilization space availability, lease differentials, turn factors, and oversell factor percentages.

Parking facility management computer system 130 may also permit a manager to contact various users (such as lessees of parking spaces) of the parking facility linked with parking facility management computer system 130. Parking management server 110, in user profile database 160, may store various contact data for users, such as e-mail addresses and phone numbers. If a parking facility has some number of leased parking spaces, the manager of the parking facility may occasionally wish to reacquire rights to at least some of those parking spaces for a period of time. As such, using parking facility management computer system 130, the manager may be able to request that parking management server 110 contact some or all of the users having a leased parking space within the parking facility and present those lessees with an offer for use of their leased parking spaces. For example, the offer may include an amount of money or a lease discount.

The manager may attempt to reacquire rights to the parking spaces for periods of time when the parking spaces are typically unused. For example, if the parking facility is located in or near an office building, the leased parking spaces may typically only be used during business hours. If a special event, such as a parade or sporting event, is occurring outside of business hours in the area of the parking facility, the manager may wish to require the rights to the leased parking spaces such that they can be resold to persons attending the special event. In such arrangements, the manager may attempt to resell the parking spaces for a greater amount of value than the manager used to reacquire the parking spaces from the lessees.

Parking management server 110 may also be in communication with a remote computer system 140. While parking management system 100 illustrates one remote computer system in communication with parking management server 110, it should be understood that multiple remote computer systems can be in communication with parking management server 110. For example, each user may use a home computer system, or other electronic device, to communicate with parking management server 110. Additionally, day users, including potential users that have not yet registered with parking management server 110, may communicate with parking management server 110 using a remote computer system.

An application that is executed locally by remote computer system 140 or a web-based application (which may be executed through a web browser) may allow users to interact with parking management server 110. Referring to users that are lessees, the users may be able to manage their leases. For example, by interacting with parking management server 110, the users may be able to make payments, renew their leases, and/or terminate their leases. If an offer has been made by a manager of a parking facility to lease back a parking space, users may be able to respond through remote computer system 140 as to whether they accept the offer made by the manager of the parking facility.

Day users may also interact with parking management server 110 via remote computer system 140 using a locally installed application that communicates with parking management server 110 or a web-based application, which may be executed through a web browser. A person who has never interacted with parking management server 110 may communicate with parking management server 110 via remote computer system 140 to register as a user. This may involve the person providing various information such as: the person's name, the person's address, identifier's of one or more vehicles linked with the person, and/or billing information (e.g., a bank account number, a debit card number, a credit card number, a stored value card number, a gift card number). This information may be stored by parking management server 110 in user profile database 160. As such, when the person enters a parking facility, such as the parking facility associated with parking facility access system 120-1, parking facility access system 120-1 may transmit the vehicle identifier of the person's vehicle to parking management server 110. Parking management server 110 may determine the vehicle identifier is linked with the user using user profile database 160. Parking fees incurred by the person at the parking facility associated with parking facility access system 120-1 may be charged to an account of the person stored by parking management server 110.

Additionally, remote computer system 140 may be used by day users to reserve a parking space in the parking facility prior to the day user driving her vehicle to the parking facility. As such, the day user may be assured that a parking space will be available for the day user's vehicle when she arrives at the parking facility. The remote computer system 140 may display a list and/or map of parking facilities linked with parking management server 110 in the region indicated by the day user in which she desires to park. Using remote computer system 140, the day user may select a parking facility at which she wishes to park her vehicle. Parking management server 110 may then reserve a parking space for the day user. As such, the parking facility access system associated with the parking facility the day user has selected may be regulated by the parking management server 110 such that at least one parking space remains empty until the day user's vehicle has entered the parking facility.

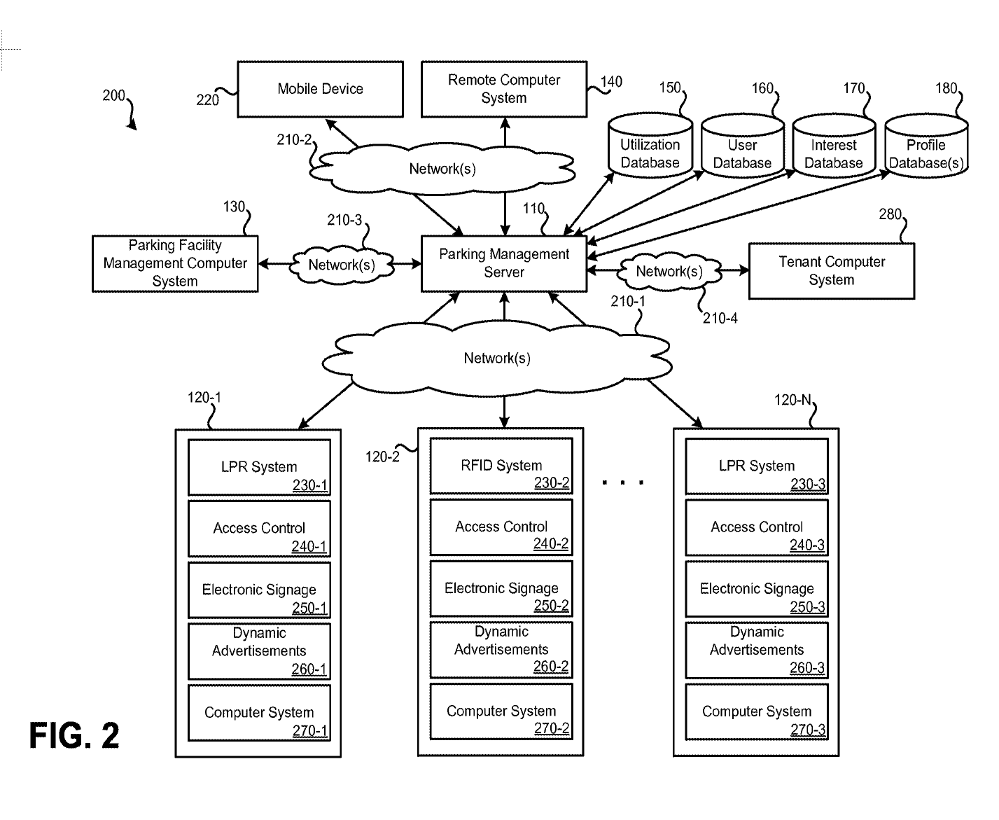

FIG. 2 illustrates another embodiment of a parking management system 200. Parking management system 200 may represent parking management system 100 of FIG. 1 or may represent some other parking management system. Parking management system 200 may include: parking management server 110, parking facility access systems 120, parking facility management computer system 130, remote computer system 140, utilization database 150, user profile database 160, networks 210, mobile device 220, and group tenant computer system 280.

Parking management server 110 may communicate with parking facility access systems 120, parking facility management computer system 130, remote computer system 140, mobile device 220, and group tenant computer system 280 via one or more networks 210. Networks 210 may include one or more private networks, such as a corporate intranet, and/or one or more public networks, such as the Internet. Further, networks 210 may include one or more wireless networks, such as a cellular network, to communicate with mobile device 220. Utilization database 150 and user profile database 160 are illustrated in parking management system 200 as in direct communication with parking management server 110. It should be understood that in some embodiments, utilization database 150 and user profile database 160 may also communicate via networks 210 with parking management server 110.

FIG. 2 illustrates various components of parking facility access systems 120. Parking facility access system 120-1 includes: license plate recognition (LPR) system 230-1, access control system 240-1, electronic signage 250-1, dynamic advertisements 260-1, and computer system 270-1. LPR system 230-1 may detect the license plate number and/or state of vehicles entering and/or exiting the parking facility at which parking facility access system 120-1 is located. As such, license plate numbers may be used as vehicle identifiers by parking facility access system 120-1.

Access control system 240-1 may prevent unauthorized entrance and/or exit from the parking facility. For example, access control system 240-1 may include a gate that blocks entrance to and/or exit from the parking facility and is moved when access to or from the parking facility is granted (such as by parking management server 110). In some embodiments, access control system 240-1 may be a retractable spike strip or some other physical device that restricts access to and from the parking facility. In some embodiments, no physical device is used to prevent entrance and/or egress from the parking facility. Access control system 240-1 may also collect payment from persons at the parking facility. For example, access control system 240-1 may include a pay station capable of reading transaction cards (such as credit cards, debit cards, stored value cards) and/or receiving cash. Such a pay station may be located at the exit of the parking facility. Payments at the parking facility (such as using the pay station) may be required by persons who have not created an account with parking management server 110. Persons who have not created an account may be directed to parking spaces in a zone of the garage designated for non-network users. For example, an electronic sign may indicate that the person is to proceed with her vehicle to level 5. One or more sensors within the parking facility may determine placement of the person's vehicle and transmit related data to the parking management server. An LPR system may still detect and store information on the person's vehicle license plate. The person may be directed to set up an account before leaving the parking facility. For example, a sign may provide a link for the person to use from a mobile device to create an account. In some embodiments, if parking management server 110 does not recognize a vehicle identifier of a vehicle, parking management server 110 may not be able to bill the fees for parking to a user account present in user profile database 160. As such, payment may be required to be made to access control system 240-1 before entrance or exit of the person's vehicle from the parking facility.

Access control system 240-1 may prevent vehicles from entrance to a parking facility based on the vehicle's characteristics. For example, if the size, weight, make, model, and/or year of the vehicle (either as detected or noted in the associated user account) does not meet certain conditions, the vehicle may be denied access to the parking facility. For example, certain large models of trucks may not be able to fit in some or all of the parking spaces within the parking facility or may be unable to negotiate certain turns within the parking facility due to the dimensions of the parking facility. In some embodiments, based on the vehicle's characteristics, the user may be directed to drive to a particular zone of the parking facility for parking.

Electronic signage 250-1 may be used to display parking rates at the parking facility to potential users. For instance, a manager using parking facility management computer system 130 may provide an indication to parking management server 110 that for a certain period of time parking rates are to be raised at the parking facility linked with parking facility management computer system 130. As such, the rates displayed at the parking facility by electronic signage 250-1 may be adjusted to reflect the new rates. The ability to dynamically vary pricing at the parking facility via the electronic signage may especially be useful when a high demand of parking in the vicinity of the parking facility is expected, such as during a special event. Electronic signage 250-1 may reflect information updates from the parking facility management computer server. Such information may include parking rates, emergency alters, advertisements, garage status (e.g., open or full), LEED certification, and wayfinding directions.

Dynamic advertisements 260-1 may be electronic displays, similar to electronic signage 250-1, that display advertisements based on various factors, such as the characteristics of a user entering and/or exiting the parking facility, the time of day, day of week, the time of year, etc. As an example, if the lessee is entering the parking facility at which parking facility access system 120-1 is located, an advertisement may be displayed to the lessee that is generally directed to someone who works in the area, such as a nearby copy shop. A different advertisement may be displayed to a day user that is arriving at the parking facility at night, such as an advertisement for a nearby restaurant. Further, if a user has provided personal information to parking management server 110, such as via remote computer system 140, this information may be used to specifically tailor advertisements to the user when the user is expected to be present in and around the parking facility, such as when the user is entering and/or exiting the parking facility in the user's vehicle. One particular form of advertising that may be effective could be a business entity using the dynamic advertisements 260-1 to indicate that the business has paid for (some or all of) the user's parking fees. As such, the user may exit the parking facility with the associated parking fees being charged to the business entity.

Computer system 270-1 may be in communication with the various other components of parking facility access system 120-1. For example, computer system 270-1 may receive license plate numbers from LPR system 230-1. Computer system 270-1 may communicate with parking management server 110. Based on communication with parking management server 110, computer system 270-1 may instruct access control system 240-1 to allow a vehicle entrance and/or egress from the parking facility. The computer system 270-1 may also instruct access control system 240-1 that payment is to be collected prior to permitting the vehicle to enter or exit. Users may access the parking management network to view their account parking facility access status (e.g., accepted or denied).

Parking facility access system 120-2 may contain at least some components similar to parking facility access system 120-1. However, rather than having LPR system 230-1, parking facility access system 120-2 has RFID system 230-2. RFID system 230-2, rather than using license plate numbers, may use RFID tags as vehicle identifiers. As such, an identifier linked with an RFID tag present in a vehicle may be stored by parking management server 110 in a database, such as user profile database 160. If an RFID tag is not present to identify the vehicle at the parking facility of parking facility access system 120-2, payment may be required to be made to access control system 240-2 before entrance and/or egress from the parking facility of parking facility access system 120-2 is permitted. While parking facility access system 120-1 has only LPR system 230-1 and parking facility access system 120-2 is illustrated as having only RFID system 230-2 in parking facility management system 200, in some embodiments, both an LPR system and an RFID system may be present in the same parking facility access system.

Mobile devices, such as mobile device 220, may be operated by a user, such as a lessee or a day user, and may be in communication with parking management server 110. Mobile device 220 may be a cellular phone. For example, parking management server 110 may store phone numbers related to users in user profile database 160. When parking management server 110 needs to communicate with a lessee or a day user, messages may be sent to a mobile device linked with the lessee or the day user. For example, if a manager, via parking facility management computer system 130, makes an offer to temporarily reacquire one or more leased parking spaces, parking management server 110 may send out one or more messages (such as text messages) to mobile devices of lessees. The messages may include details of the offer made by the manager. From their mobile devices, lessees may be able to respond to either accept or reject the offer. If the offer is rejected, parking management server 110 may contact additional lessees in attempts to reacquire the number of parking spaces desired by the manager.

If a day user, via either remote computer system 140 or mobile device 220, requests a parking space at a parking facility be reserved, information regarding that parking facility may be transmitted to a mobile device linked with the day user. For instance, directions to the parking facility and/or weather information may be transmitted to the mobile device. Digital mapping of the facility and garage may give access to customers to view directions to and from the parking facility (from beginning and ending points) alone with turn-by-turn directions in the garage that take them to a designated parking space. A map of the inside of the parking facility may also be transmitted to the mobile device. If the user has been permitted to select a particular parking space or zone with the parking facility, the map may display the location of the parking space or zone and how to get to the parking space or zone from the parking facility's entrance. Additionally, advertisements, such as in the form of offers for various restaurants or stores in the area of the parking facility, may be transmitted to mobile device of the day user.

Mobile device 220 may also be used to receive messages regarding charges to the user's account. Users may look at their statement months later and forget if they parked at the locations specified on their account statement. As such, a “receipt” may be used for some or all parking facility fees that are paid from the account. For example, after a user leaves a parking facility she may receive a text or email confirmation stating “Thank you for parking at “XYZ” location, your parking fee is $10.00 and will be charge to your account”. Reminders for fees paid may also be displayed when the user logs into her account from a remote computer system. This may help decrease disputes over parking charges.

While only mobile device 220 is illustrated in FIG. 2, it should be understood that parking management server 110 may be in communication with many other mobile devices. For example, for some or all of the users present in user profile database 160, parking management server 110 may periodically be in communication with a mobile device associated with each user.

Mobile device 220 and remote computer system 140 may also be used to receive other communication. For example, parking alerts (e.g., parking facility closures, construction notices, security alters, reminders, changes in lease terms) may be transmitted to users. Additionally, users may be notified of violations, such as speeding within the parking facility. Fines may be assessed against a user's user account. In some embodiments, a parking management server can automatically assess fines for parking facility rule violations. Similarly, a user may use mobile device 220 and/or remote computer system 140 to report incidents (e.g., vehicle accidents) within the parking facility to the parking facility's management. Mobile device 220 may also be used to receive information from an attendant at a parking facility where a user's vehicle is parked. For example, if the attendant notes the vehicle has its lights left on, the attendant may be able to use the vehicle identifier (e.g., license plate number) to identify the vehicle and indicate the vehicle has its lights on. The parking management server may determine a user account and/or mobile device linked with the vehicle identifier and send a text message, email, voice message, or some other indication to the user to inform her about her vehicle. Such an arrangement may not require the user's person information (e.g., mobile device phone number) to be revealed to the attendant. Rather, the parking management server determines the appropriate mobile device phone number to use to contact the user linked with the vehicle identified by the attendant.

Parking management server 110 may also be in communication with one or more group tenant computer systems, such as group tenant computer system 280. Group tenant computer system 280 may be used by a local building occupant (or some other entity) that has rights (such as leases) to a group of parking spaces within a parking facility. The group tenant may be responsible for payment to the parking facility manager for the use of the parking spaces rather than the individual users of the parking spaces. For example, a group tenant may be a corporation that has an office near a parking facility, and has acquired a number of parking spaces for the corporation's employees. Group tenant computer system 280 may permit the group tenant to interact with parking management server 110 via a software application locally installed on group tenant computer system 280 or via a web-based application (which may be executed through a web browser).

Using group tenant computer system 280, a group tenant may be able to allocate its leased parking spaces as desired. For example, the group tenant may be able to allocate its parking spaces to particular employees, such as by having each employee provide account information and provide a vehicle identifier and/or usernames of employees. Also, the group tenant may be able to pay for the leases on its parking spaces, acquire additional parking spaces, and/or end of the lease of parking spaces. Additionally, via group tenant computer system 280, a group tenant may be able to validate parking for a guest parked in the parking facility where the group tenant has a group of parking spaces, or any other parking facility in communication with parking management server 110. For example, if a group tenant wishes to validate parking for a guest, the group tenant, via group tenant computer system 280, may provide a vehicle identifier of the guest's vehicle, such as the guest's vehicle's license plate number. Upon the guests and the guest's vehicle entering and/or exiting the parking facility, no payment may be required from the guest and the access control system of the parking facility access system may not obstruct the guest's vehicle because the group tenant has validated the guest's parking. The group account administrator of a group tenant may set up a “validation account” which is sub-linked to the group account. The group tenant may identify which parking facility locations they want to validate for. No payment by guests of the group tenant at these parking facilities may be required: to transfer a fee, the guest may present to the group tenant a member identification card to be scanned, provide license plate information, and/or account number information. Once provide to the parking management server via the group tenant computer system, the parking transaction will appear on the group tenant computer system, and may indicate the guest's name, entry time and estimated fee upon exit from the parking facility. An option may be presented asking if the group tenant desires to validate the parking transaction. If the group tenant accepts charges (transfers the charges from the guest) the guest may exit the parking facility at no charge and the parking transaction may be reflected in the details of the group tenant's account.

For a particular guest, a group tenant, via a group tenant computer system, may enable reoccurring validation. This may be useful so that the group tenant can pay for the guest's parking fees over a period of time. As an example, a business traveler may need to visit a parking facility multiple times over the course of a week. A group tenant may enable reoccurring validation for the guest based on the guest's name, and/or a license plate number. The group tenant may also provide a period of time over which the guest's parking fees are validated.

If a group tenant has validated a guest's parking, the group tenant may be notified when, such as via an email or phone call, when the guest has arrived at the parking facility. For instance, when the guest's license plate number is detected at the entry of the parking facility, the group tenant that validated parking for the guest may be notified. If the group tenant validates parking before the guest arrives, the guest may receive a calendar item (or other form of reminder) via email, phone, or text message, that indicates the period of time over which the validation is valid. The calendar item may include directions, a parking space number, and/or other information that the group tenant may desire to provide to the guest.

Accordingly, a group tenant may have multiple options for validating a guest's parking. First, the tenant, via the tenant computer system, may validate the guest's parking prior to the guest leaving the parking facility. In such an arrangement, the guest's parking may be validated on a one-off or reoccurring basis. Second, the group tenant may be able to validate the parking and transfer the associated costs to another billing system. For example, a hotel (the group tenant) may validate a guest's parking such that the guest can park at a parking facility. The hotel may then transfer the parking fees to a the guest's hotel bill. The cost transferred to the guest may be discounted or increased by the hotel. Third, validation may occur based on location of a vehicle within a parking facility. This may be useful for the management company of the parking facility. As an example, janitorial, security, delivery, and/or construction vehicles which park in designated parking spaces (e.g., a loading dock, loading zone, etc.) may automatically have their parking validated. Accordingly, particular parking spaces may be monitored and vehicles that park in these spaces may automatically be validated to park for free or a discounted rate. The presence of such designated parking spaces (e.g., loading docks) may be specified when the profile of the parking facility is initially created or modified. Fleet vehicles (e.g., delivery service vehicles, livery vehicles, repair service vehicles, taxis, etc.) may be validated based on their location within a parking facility. For example, if a delivery truck enters the parking facility to make a delivery, it may be automatically validated, such as based on where the vehicle stopped within the parking facility, an insignia of the vehicle, and/or the license plate number of the vehicle. If a fleet vehicle that is expected to use a loading area enters the parking facility and the loading area is full, directions to an alternate loading area for the fleet vehicle may be provided. A management company associated with a parking facility may be alerted if a loading area within its parking facility is full or overloaded. Further, based on the expected schedule of such fleet vehicles, the management company may be alerted as to a potential future scheduling problem.

A group tenant may access validation transaction details of the group tenant's account. A guest's name may be selected to send a “Thank You” and/or some other form of notification after the guest has left the group tenant's location. Other forms of notifications include surveys (which a guest may complete and submit, possibly in exchange for future consideration, such as a discount). This notification may be accomplished through a notification platform and/or advertisement platform that utilizes data of the guest's user account. For example, if a retail store validates a customer's parking, the retail store may also want to send the customer discounts for the customer's next visit to the retailer. The customer may receive and/or save the discounts and/or promotions through the customer's parking profile. In some embodiments, if the customer's parking profile has the customer's email address, the discounts and/or promotions may be emailed to the customer. As another example, a guest may visit a tenant of an office building. A group tenant of the building may want to say “thank you” by providing the guest with discount on business services, promotion items, and/or a message. By having validated the guest's parking, the ability to send such information to the user may be available, possibly without personal details of the guest being made available to the group tenant. For instance, the information desiring to be transmitted to the guest may be provided by the group tenant to the parking management server, which may then forward the information to the guest. The guest's personal information (e.g., address, email account) may not be revealed to the group tenant.

While only group tenant computer system 280 is illustrated in FIG. 2, it should be understood that parking management server 110 may be in communication with many other group tenant computer systems. For example, for each group tenant that has a group of parking spaces leased in a parking facility or desires the ability to validate parking for guests, parking management server 110 may at least periodically be in communication with an associated tenant computer system. Further, to validate parking, a business, corporation, person, or other entity may not need to be leasing a group of parking spaces. Rather, the entity may have an account with the parking management server 110 that allows the entity to validate parking of other vehicles and pay for such associated parking fees.

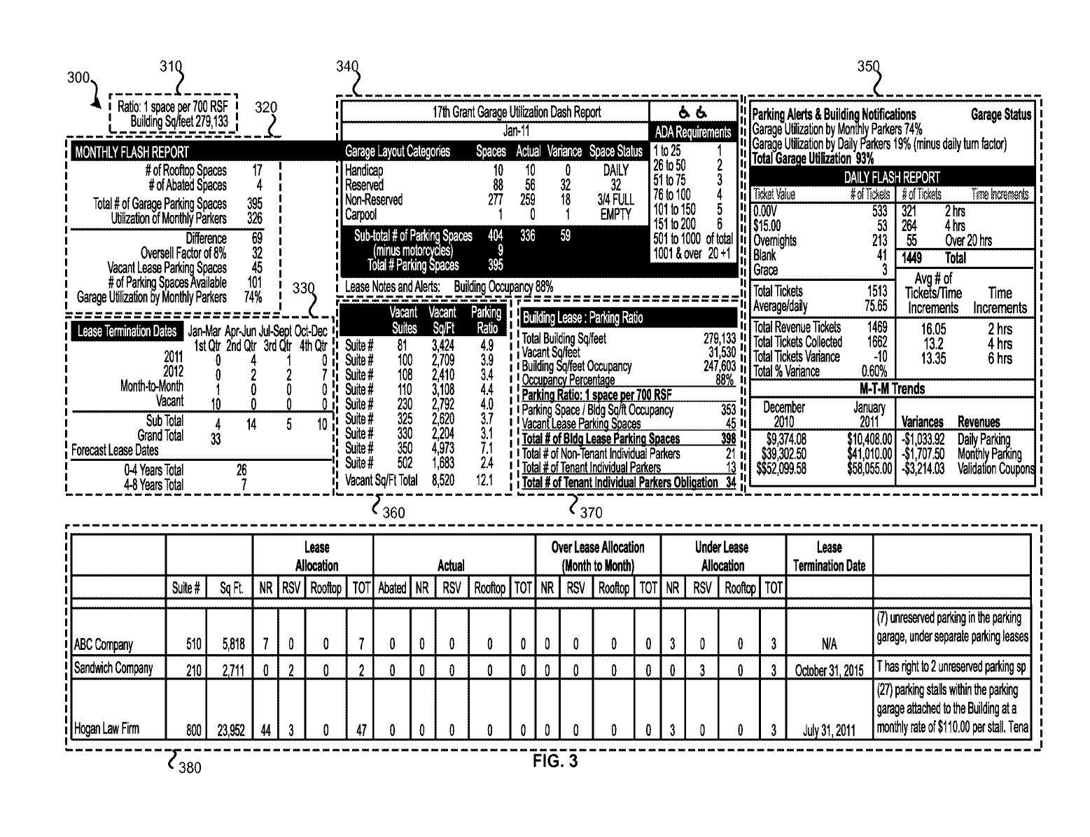

FIG. 3 illustrates an embodiment of a parking facility management dashboard 300. Such a parking facility management dashboard may be presented to an owner and/or manager of a parking facility via a parking facility management computer system, such as parking facility management computer system 130 of FIGS. 1 and 2. Parking facility management dashboard 300 may be presented in either real-time or near real-time.

Parking facility management dashboard 300 may present various parking facility and associated building statistics to a manager and/or owner of a parking facility. If a parking facility is a stand-alone parking facility, no associated building statistics may be provided. In the illustrated embodiment of parking facility management dashboard 300, the parking facility is part of (or associated with) an office building (e.g., is below the office building). In region 310 of parking facility management dashboard 300, a display of a building's total square feet and the number of parking spaces in the parking facility per rentable square feet (RSF) is provided.

In region 320 of parking facility management dashboard 300, a monthly report may be presented detailing the utilization of the parking facility (e.g., the number of vehicles being parked in the parking facility). This monthly report may break down the utilization according to different types of parking spaces available within the parking facility. For example, the parking spaces may be broken down according to various zones, including: rooftop spaces (e.g., on the roof of the parking facility where the vehicle may be uncovered), surface spaces (e.g., in a surface parking lot), reserved spaces (e.g., numbered spaces assigned to a particular person or entity) and a non-reserved spaces (e.g., parking spaces not assigned to a particular person or entity). This monthly report may provide the difference between the number of parking spaces available in the garage and the number of parking spaces leased, rented, or otherwise assigned to monthly parkers (e.g., lessees). Information may also be displayed regarding an oversell factor, the number of parking spaces available for lease that are vacant, and the percentage of parking spaces that are utilized by lessees.

In region 330 of parking facility management dashboard 300, various information regarding lease termination dates may be provided. A breakdown per quarter and per year of when leases terminate may be provided. Also, forecast of the lease termination dates broken down by year, or multiyear periods may also be provided.

In region 340 of parking facility management dashboard 300, real-time and/or near real-time information may be provided for various parking space categories within the parking facility. For example, referring to region 340, parking space categories of handicapped, reserved, non-reserved, carpool, large vehicle designation, visitor parking area, and motorcycle are broken out. The total number of spaces available in each category may be displayed, “actual” may represent the number of parking spaces occupied or otherwise unavailable. The variance between the total number of spaces present in the garage and the actual in each category is also displayed. Also, a status for each category of spaces is displayed. This space may indicate approximately how many of the spaces within each category are filled. Also, in region 340, a display indicating ADA (Americans with Disabilities Act) requirements. Based on the total number of parking spaces in the parking facility, the number of required handicapped parking spots may be identified.

In region 350 of parking facility management dashboard 300, information regarding parking facility utilization by lessees and day users may be presented. For example, the number of transactions may be broken down according to value, time increments, number of transactions per time increments, number of transactions issued on average per day, the total number of transactions performed, number of transactions that resulted in revenue, number of transactions that did not result in revenue, the number of transactions initiated, number of transactions collected on, and the difference between the number of transactions initialed and collected on. Additionally, information regarding the amount of money earned from day users, lessees, and validated users (e.g., validated by a tenant or have a coupon that can be redeemed for parking) may also be presented in region 350.

In region 360 of parking facility management dashboard 300, information related to building occupancy may be displayed. An embodiment of parking facility management dashboard 300, the amount of vacant square feet per suite, and the associated parking ratio is displayed. As such, in the illustrated embodiment, for approximately every 700 vacant square feet, a parking space is associated with the respective suite.

In region 370 of parking facility management dashboard 300, information related to leases and parking ratios may be displayed. This region of the parking facility management dashboard 300 may include information on the building's total square feet, the building's vacant square feet, the building's square-foot occupancy, and the occupancy percentage of the building. Assuming one parking space per 700 rentable square feet, the parking space per building's square-foot occupancy in the vacant lease parking spaces is also displayed. The total number of building lease parking spaces may be displayed. Further, the total number of non-tenant individual parkers (e.g., persons leasing a space that are not associated with a building tenant), the total number of tenant individual parkers (e.g., persons leasing the space that are associated with leased, rented, or owned space within the building), and the total number of individual parkers' obligations (e.g., the total number of tenant and non-tenant individual parkers) may be displayed.

In region 380 of parking facility management dashboard 300, information related to leases may be displayed. In this region, each tenant leasing a group of parking spaces may be listed. Linked with each tenant may be information in the following categories: suite number, square footage of the suite, number of non-reserved parking spaces, number of reserved parking spaces, number of rooftop parking spaces, and total number of parking spaces allocated to the tenant. Additionally, linked with each tenant may also be the following information: in actual number of repeated parking spaces, then actual number of non-reserved parking spaces, the lease rate structure, the lease to parking space ratio, lease renewal information and actual number of reserved parking spaces, and actual number of rooftop parking spaces, and a total number of actual parking spaces. Further, a number of non-reserved parking spaces, reserved parking spaces, rooftop parking spaces and the total number of parking spaces over a lease allocation on a month-to-month basis may be displayed for each tenant. Also displayed may be a number of parking spaces under the lease allocation for each category of parking spaces. A termination date for each release may also be listed for each tenant. Finally, various comments and notes may be listed for some or all of the tenants.

Parking facility management dashboard 300 displays various pieces of information which may be useful to a manager of a parking facility. Parking facility management dashboard 300 may permit the owner to modify such information. It should be understood that the information displayed in parking facility management dashboard 300 is not intended to be limiting. Similar information may be displayed in a different format. In some embodiments, less information or additional information may also be displayed via parking facility management dashboard 300. In some embodiments, the manager may be permitted to modify the presentation of parking facility management dashboard 300.

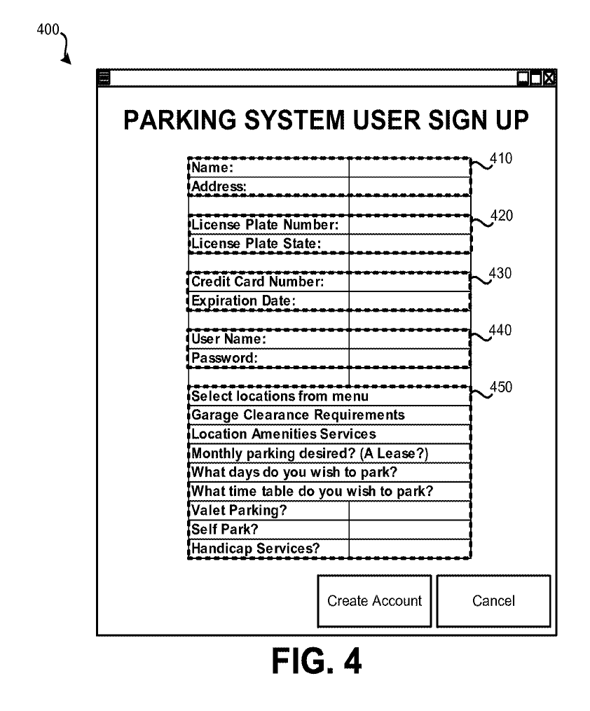

FIG. 4 illustrates an embodiment of a parking system graphical user interface 400. Parking system graphical user interface 400 may be presented to a person who wishes to interact with parking management server 110. Parking system graphical user interface 400 may be presented to a user via a remote computer system such as remote computer system 140 of FIGS. 1 and 2 and/or a mobile device, such as mobile device 220 of FIG. 2. Graphical user interface 400 may collect a name and address for a person wishing to interact with parking management server 110 in region 410. Additionally, for parking at a parking facility that utilizes license plate recognition technology, the license plate number and state of the user's vehicle may be collected in region 420. If the user wishes to have multiple vehicles associated with her account, the user may be presented with the opportunity to provide additional license plate numbers. Additional vehicle information that may be required to be provided by the user can include the make, model, year, and color of the user's vehicle or vehicles.

Billing information may also be collected from the user via the parking system graphical user interface 400 in region 430. The user may have the ability to provide bank account information, debit card information, credit card information, checking account information, stored value account information, and/or gift card information. In the embodiment of FIG. 4, the user has selected to provide credit card information. As such, once the user has begun to use parking facilities linked with parking management server 110, parking fees may be charged to the credit card account links with the credit card number provided by the user. Additional billing information may include employer contact information, and e-mail address, a cell phone number, and/or an alternative phone number. Via region 440, the user may also create a username and password such that the user can log into his account at a later time.

Other information may also be gathered about the user via region 450. For example, if a parking facility that uses RFID tags to identify vehicles is to be used, the user may provide an identifier linked with the RFID tag present in the user's vehicle. The user may also be able to specify whether he wishes to receive various notifications, such as for information related to the parking facility and/or geographic area where the user intends to park. The user may also be able to specify whether the user is adjusted in various amenities, such as carwashes, vehicle detailing, service repair, roadside emergency services, etc. The user may also be prompted to provide a preferred geographic area which may include specifying a state, city, and/or parking facility. The user may also specify a preference for a type of parking, such as non-reserved, reserved, rooftop, surface, handicapped, etc. The user may also be prompted to provide additional information if the user is related to (e.g., an employee of) a building tenant that has a relationship with one or more parking facilities. If so, the user may be provided with preferential parking rates for one or more of the parking facilities. The user may be required to provide the user's driver's license number, the user's driver's license expiration date, and the state that issued the driver's license.

Other information which may be used to assist a user in selecting a parking facility may also be collected via region 450. Information regarding the amount of clearance required by the vehicles of the user may be collected, what days of the week the user is likely to want to park (e.g., weekdays only, weekends only), what time of day the user is likely to want to park (e.g., day, night), whether valet parking is desired, whether self parking is desired, and/or if any handicap services (e.g., a van accessible parking space, elevator) are required.

Graphical user interface may permit a user (or person who has not yet registered) to purchase gift cards and/or receive on-line gift cards from other users. The amount may be transferred between accounts of the sender and recipient. For non-account holders, gift cards may be purchase at any retail stores and given to anyone who may wish to park at any of the parking facilities linked with the parking management server. The store gift card may have instructions on how to redeem purchase either by accessing the parking network system to set up an account and/or by a current user who enters the gift card identification number via graphical user interface 400. The amount of the gift card may be reflected on the user's billing account summary.

Additionally, when a user signs up via parking system graphical user interface 400, the user may be prompted to indicate whether the user is an individual parker or should be linked to a group account (e.g., a corporate parking account of a company). If the user indicates that he or she should be part of a group account, the user may be prompted to indicate the group to which the user belongs, such as the user's employer. By specifying a particular group, this may permit a manager of the group to view and modify the user's access rights. For instance, a manager of the group may be able to confirm that the user should be permitted access in accordance with the group account. The manager of the group may also be able to evict the user from the group and/or assign the user a parking space or type of parking space from the group account's available parking spaces.

The illustrated embodiment of parking system graphical user interface 400 of FIG. 4 is merely an example. The format in which information is collected from a user may vary. Multiple graphical user interfaces may be used to collect similar information. In some embodiments, additional or less information is collected from users and persons enrolling as users.

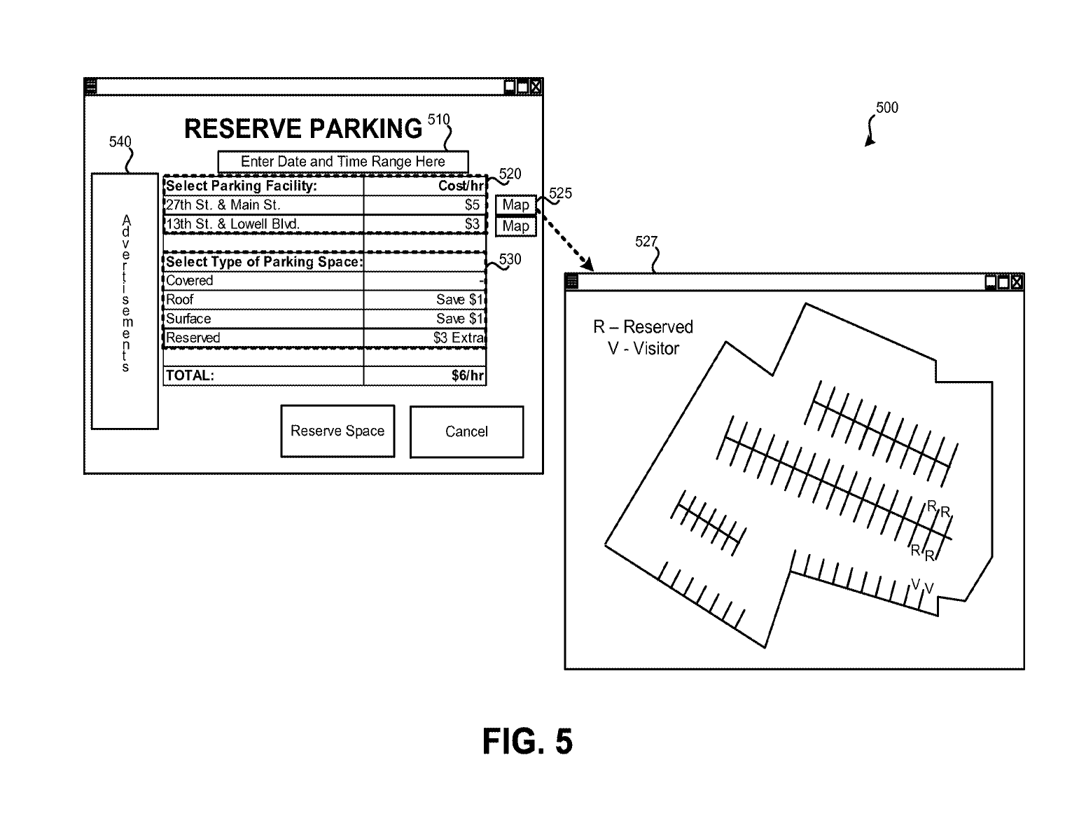

FIG. 5 illustrates another embodiment of a parking system graphical user interface 500. Parking system graphical user interface 500 may be used by a day user to reserve a parking space remotely. For example, parking system graphical user interface 500 may be accessed from a remote computer system or a mobile device via a day user such that the day user will be assured that when the day user arrives at the parking facility a parking space will be reserved for her vehicle. Parking system graphical user interface 500 may allow the user to select a parking facility in region 520. Associated with each parking facility may be a rate (which may be per hour, per day, or per some other time period). Additionally, the user may be able to specify a zone (in region 530) within a parking facility that she desires, such as a reserved parking space, a covered parking space, a rooftop parking space, surface parking space, etc. The type of parking space reserved by the user may result in the rate associated with parking at the parking facility varying. In some embodiments, some or all parking facilities may permit a user to select a particular parking space. For example, selecting map button 520 may display map 527 of the associated parking facility. The day user may then select the parking spot that the day user wishes to reserve. Unavailable parking spaces (e.g., parking spaces already occupied or already reserved) may be indicated as such on the map.

The user may also be required to enter a date and a time range (in region 510) in which she intends to park. Based upon characteristics of the user, possibly including information such as the date and time range entered in the parking facility selected, one or more advertisements (in region 540) may be displayed to the user. These advertisements may be targeted to the user based on the user's characteristics. As those with skill in the art will recognize, the various regions of parking system graphical user interface 500 may be reconfigured. Further, more or less information may be requested from users to reserve a parking space in a parking facility.

The illustrated embodiment of parking system graphical user interface 500 of FIG. 5 is merely an example. The format in which information is collected from a user and presented to the user may vary. Multiple graphical user interfaces may be used to collect and/or present similar information. In some embodiments, additional or less information is presented to and/or collected from users reserving parking.

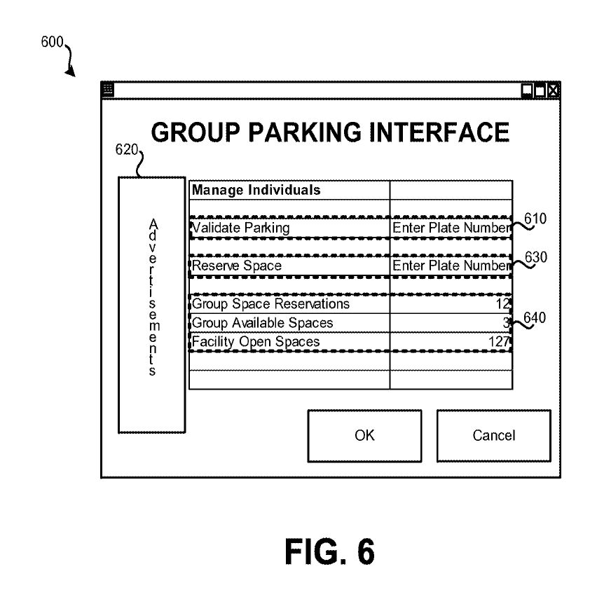

FIG. 6 illustrates an embodiment of a parking system graphical user interface 600. Parking system graphical user interface 600 may permit an entity, such as a tenant, to manage a group of one or more parking spaces leased from a parking facility via a parking management server. For example, parking system graphical user interface 600 may be presented to a user by tenant computer system, such as group tenant computer system 280 and communicate with a parking management server such as parking management server 110 of FIGS. 1 and 2, allowing the group tenant to manage a group account.

In region 610, a group tenant (or other entity that wishes to pay for parking of a person with a vehicle in a parking facility) may be able to validate parking. This may be used for a guest parking in a parking facility in communication with the parking management server. By validating parking for a vehicle, such as by entering a vehicle identifier of the vehicle or a user name that the guest has established with the parking management server, the tenants may be billed for any parking fees incurred by the vehicle within the parking facility. In region 630, if a group tenant (or other entity) wishes to reserve a parking space for a vehicle, the tenant may be permitted to enter a vehicle identifier, such as a license plate number, or a username, and reserve a parking space. As such, the parking management server may regulate access to the parking facilities such that a space is reserved for the vehicle linked with the vehicle identifier (and user name) provided by the tenant.

Additionally, in region 640, information regarding parking spaces within the parking facility may be provided to the group tenant. For example, the number of spaces reserved for the group tenant may be displayed. The number of these parking spaces currently unoccupied may be displayed. Further the total number of available parking spaces within the parking facility may be displayed. In some embodiments, a map of the parking facility may be displayed, which may show available parking spaces and/or the parking spaces allotted to the group tenant.

Further, if various persons (e.g., employees, vendors) linked with the group account of the group tenant have access to the group tenant's parking spaces, access by these persons may be regulated via the group tenant interface. For example, by adding or deleting either usernames and/or vehicle identifiers, the group tenant may be able to control access to its group parking spaces. One or more advertisements 620 that are directed to the group tenant may be displayed by parking system graphical user interface 600.

The illustrated embodiment of parking system graphical user interface 600 of FIG. 6 is merely an example. The format in which information is collected from a user and presented to the user may vary. Multiple graphical user interfaces may be used to collect and/or present similar information. In some embodiments, additional or less information is presented to and/or collected from group tenants.

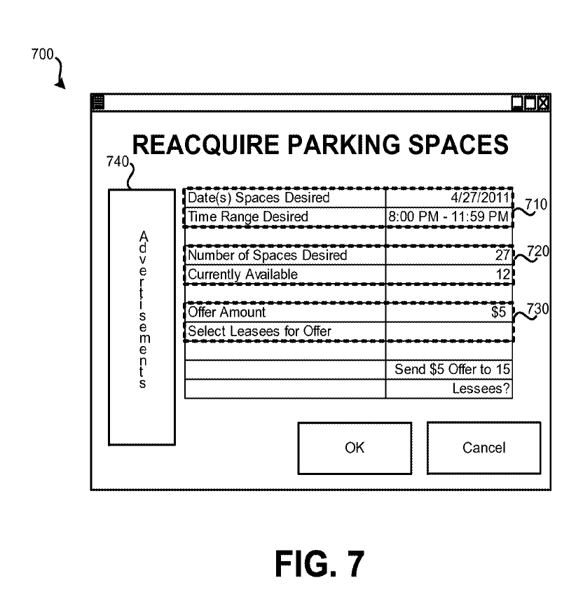

FIG. 7 illustrates an embodiment of a parking system graphical user interface 700. Parking system graphical user interface 700 may allow a manager to reacquire the rights to parking spaces within a parking facility. A manager using parking facility management computer system 130 may communicate with parking management server 110 using parking system graphical user interface 700. In region 710, the manager may specify the date or dates on which parking spaces are desired to be reacquired. The manager may also specify a time range over which the manager wishes to reacquire the parking spaces. In region 720, the manager may specify the number of parking spaces that the manager desires to reacquire. In region 730, the manager may specify an amount of money (or other consideration) to offer lessees for temporary use of the lessees' parking spaces. The manager may also have the option of selecting specific lessees who are to receive the offer. In region 740, one or more advertisements directed to the manager of the parking facility may be displayed.

When the manager submits the offer to the parking management server, the parking management server may contact the lessees until the number of spaces desired by the manager have been obtained. For example, if 27 spaces are desired by the manager, the offer may be initially submitted to 27 lessees. The lessees who initially receive the offer may be selected by the parking management server. For example, lessees may have an option of selecting whether they are to receive such offers or not. If 15 lessees reply that they are not interested in the offer, or a period of time elapses without a response from the lessees, 15 additional lessees may be presented with the offer. In some embodiments, the offer is presented to all lessees. However, the offer may only be accepted by those lessees (in this example, 27 lessees) first to respond.

The illustrated embodiment of parking system graphical user interface 700 of FIG. 7 is merely an example. The format in which information is collected from a manager and presented to the manager may vary. Multiple graphical user interfaces may be used to collect and/or present similar information. In some embodiments, additional or less information is presented to and/or collected from managers reacquiring parking spaces. While above example details reacquiring parking spaces from individuals, a manager may also be able to reacquire rights from group tenants.

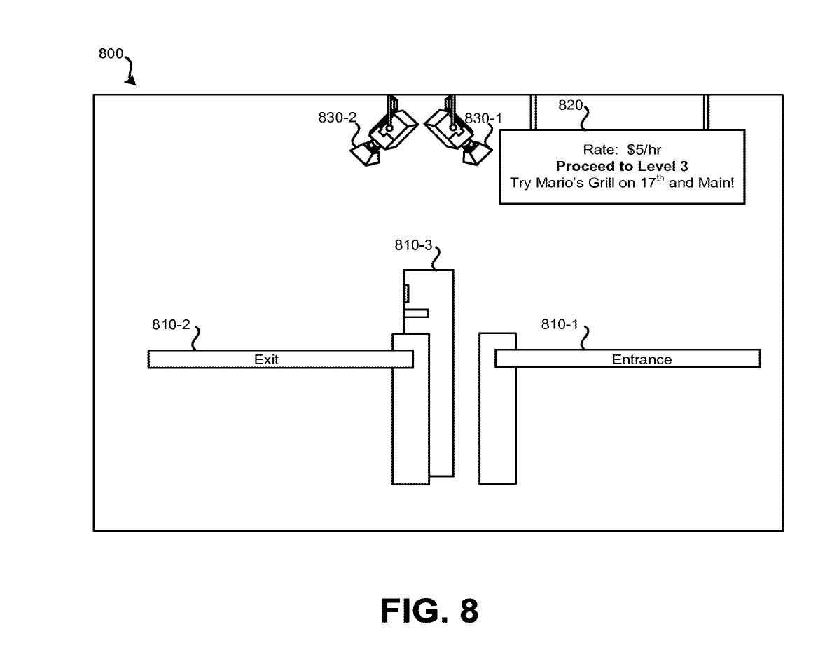

FIG. 8 illustrates an embodiment of a parking facility access system 800. Parking facility access system 800 may represent parking facility access system 120-1 of FIG. 2. Parking facility access system 800 may include: access control system 810, electronic signage/dynamic advertisements 820, and LPR cameras 830. Access control system 810 may include gate 810-1, gate 810-2, and pay station 810-3. Upon a vehicle pulling up to entrance gate 810-1, a camera 830-1 of an LPR system may detect the license plate number of the vehicle. Based upon the license plate number of the vehicle, as analyzed by a parking management server, access may or may not be granted to the parking facility. In parking facility access system 800, the electronic signage displaying the rate of the parking facility and the dynamic advertisement display are combined. Electronic signage/dynamic advertisements 820 may display advertisements, rate information, and/or directions to the parking area where a user is to park the user's vehicle. Upon exit from the parking facility, exit gate 810-2 may prevent exit by a vehicle until either payment is made using pay station 810-3 or camera 830-2 detects the license plate number of the vehicle attempting to exit and receives authorization from a parking management server to permit exit of the vehicle without payment being received by pay station 810-3.

Electronic signage/dynamic advertisements 820 may also be used to redirect a user to an open parking space. For example, if a user previous reserved a particular parking space but the parking space is not available due to another user overstaying their allotted time in the same parking space, it may be necessary to shift the user to another parking space, either at the same parking facility or a different parking facility. Similarly, if the user reserved a particular type of parking space which is not available, the user may be redirected to another type of parking space at the same or a different parking facility. Similar information may also be sent to a mobile device (e.g., cell phone) of the user.

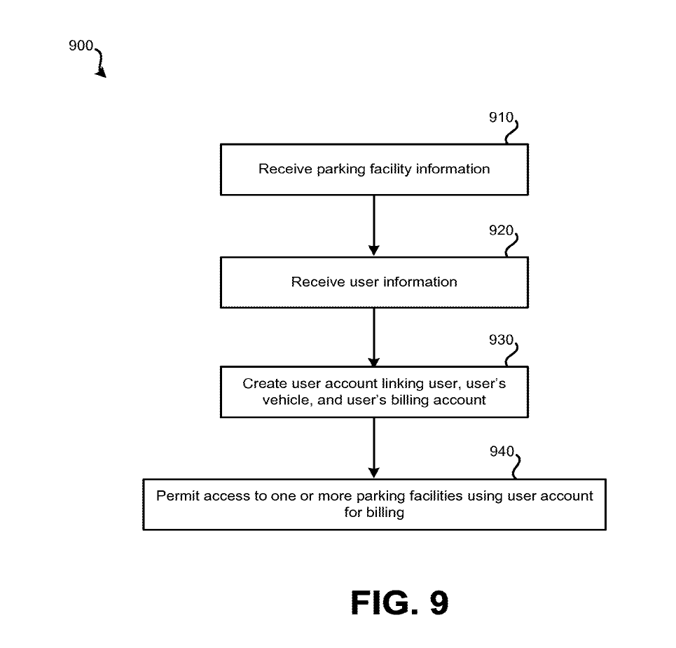

The various systems and graphical user interfaces previously described may be used to perform various methods. FIG. 9 illustrates an embodiment of a method 900 for creating a user account for a parking management system. Method 900 may be performed using a parking management system, such as parking management system 100 of FIG. 1 or parking management system 200 of FIG. 2. Other forms of parking management system may also be used to perform method 900.

At stage 910, a parking management server, such as parking management server 110 of FIGS. 1 and 2, may receive information about one or more parking facilities. Information on one or more parking facilities may be received by the parking management server from a parking facility management computer system, such as parking facility management computer system 130 of FIGS. 1 and 2. The information received regarding each parking facility may contain sufficient information for the parking management server to control access to the parking facility. For example, information regarding the number of parking spaces within the parking facility may be received. Additional information that may be received by the parking management server may include: the location of the parking facility (e.g., an address); the number of different types of parking spaces available within the parking facility (e.g., the number of rooftop spaces, the number of reserve spaces, number of non-reserved spaces); lease information on parking spaces within the parking facility; a map of the parking facility; etc.

At stage 920, user information may be received by the parking management server. The user information received may be sufficient to establish an account for a new user. For example, information which may be received includes: contact information (including the user's name, address, city, state, zip code, e-mail address, cell phone number, alternative phone number, company name, an indication of whether the user is linked with a tenant in a building associated with the parking facility, whether the user has a building access device, an identifier linked with the building access device, a driver's license number, a driver's license expiration date, and the state issuing the driver's license), vehicle information (including the number of vehicles the user wishes to register, the license plate number, the make, model, year, and color for each vehicle to be registered), billing information (including company contact information, a billing address, city, state, zip code, e-mail address, cell phone number, and an alternative phone number), the type of parking access desired (including a zone of the parking facility, and a number of parking spaces), a type of account (such as individual or group). In some embodiments, only some of this information is required and/or received. Additional information may also be received. For instance, a user who will be leasing a parking space may be required to provide more information than a day user registering to be a day user.

At stage 930, a user account may be created based on information received at stage 920. This user account may serve to link fees incurred as parking facilities linked with the parking management server to the appropriate user account. As such, if the vehicle enters and/or exits a parking facility linked with the parking management server, the parking management server may be configured to use an identifier of the vehicle, such as a license plate number, to identify a user account linked with the vehicle. If an associated user account is located, payment at the parking facility may not be required. Rather, the user's account may be billed for the parking fees incurred by the vehicle. Because a parking management server may be in communication with parking access control systems at multiple parking facilities, a user account may be billed for parking at parking facilities owned by different entities. As such, having an account with the parking management server may allow the user to park the vehicle that many parking facilities owned by different entities nationwide (or even worldwide). Further, if license plate numbers are used as a vehicle identifier, no additional hardware, such as RFID tag or a sticker (which may display a barcode or other machine-readable code), may need to be installed on the vehicle that is to use the parking facilities.

At stage 940, when the vehicle enters and/or exits a parking facility linked with the parking management server, access may be allowed without any input from the operator of the vehicle. For example, the license plate number of the vehicle may be acquired by a license plate recognition system upon entrance and exit and transmitted to the parking management server. Parking fees may be charged to the user account linked with the vehicle identifier upon the vehicle exiting the parking facility. Upon exiting the parking facility, electronic signage may be used to display to the operator of the vehicle the amount of parking fees incurred that are being charged to the user account.

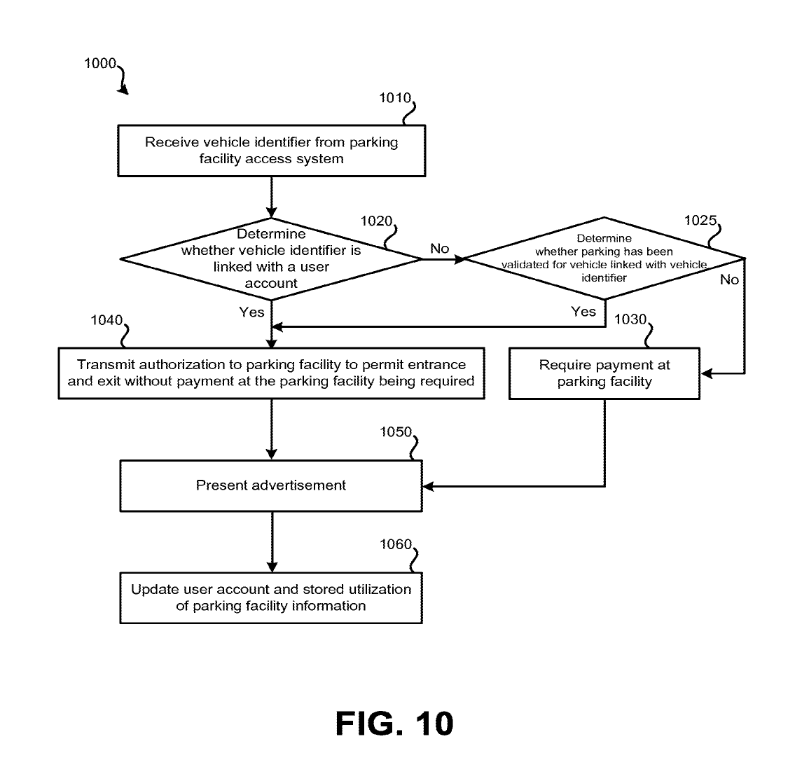

FIG. 10 illustrates an embodiment of a method for permitting use of a parking facility without requiring payment to be provided at the parking facility. Method 1000 may be performed using a parking management system, such as parking management system 100 of FIG. 1 or parking management system 200 of FIG. 2. Some other form of parking management system may also be used to perform method 1000.

At stage 1010, the vehicle identifier may be received by a parking management server from a parking facility access system. This may occur when a vehicle attempts to enter and/or exit the parking facility. If the parking facility access system uses license plate recognition, the vehicle identifier may be a license plate number. Referring to the parking management system 200 of FIG. 2, if the vehicle is at the parking facility of parking facility access system 120-1, LPR system 230-1 may capture the license plate number of the vehicle. The license plate number to be transferred to computer system 270-1. Computer system 270-1 may transfer the license plate number to parking management server 110. In other embodiments, the vehicle identifier may be linked with an RFID tag.

At stage 1020, the parking management server may determine whether the vehicle identifier received at stage 1010 is linked with a user account. This may involve the parking management server searching a user database to determine if the received vehicle identifier matches a vehicle identifier on record that is linked with a user account. If not, at stage 1025, it may be determined whether parking has been validated, such as by a group tenant, for the vehicle linked with the vehicle identifier. If not, payment may be required to be made at the parking facility at 1030. Payment at the parking facility may require a person to make either a cash or credit transaction at a pay station, such as pay station 810-3 of FIG. 8. Despite no user account being linked with the vehicle identifier, an LPR system may be used to track the amount of time the vehicle has spent within the parking facility. As such, no ticket or card may need to be issued to the operator of the vehicle upon entrance to the parking facility. Similarly, no ticket may need to be produced by the vehicle's operator to the pay station upon exit of the parking facility. Rather, the pay station may indicate the amount of time spent by the vehicle in the parking facility and require payment of associated parking fees.

If the vehicle identifier is determined to be linked with the user account at stage 1020, or the parking for the vehicle linked with the vehicle identifier has been determined to be validated at stage 1025, method 1000 may proceed to stage 1040. At stage 1040, the parking management server may transmit authorization to the parking facility that indicates access (entrance and exit) is permitted without payment being required at the parking facility. For example, the parking management server may transmit an indication to the parking facility access system of the parking facility that instructs an access control system to permit the vehicle entrance and/or exit from the parking facility. This may involve raising one or more gates.

At stage 1050, an advertisement, such as via a dynamic advertisement display, may be presented to the operator of the vehicle upon entrance and/or exit from the parking facility. If the vehicle is linked with the user account, the one or more advertisements displayed may be targeted to characteristics of the user account. If little information is known about the operator of the vehicle, such as if the operator of the vehicle is not linked to a user account, the advertisement may be based on characteristics external to the operator of the vehicle, such as the time of day, day of week, the weather, etc.

At stage 1060, likely upon the vehicle exiting the parking facility, the user account (if present) may be updated. This may involve modifying the user account to reflect the parking fees incurred at the parking facility. This may also involve billing the parking fees to a billing account on record in the user account. Information regarding the parking fees may be stored and linked with the user account such that at a later time the user can retrieve previously billed parking fees for review. Additionally, at stage 1060, utilization information may be updated for the parking facility. As such, information displayed via a parking facility management computer system, such as parking facility management dashboard 300 of FIG. 3, may be updated.

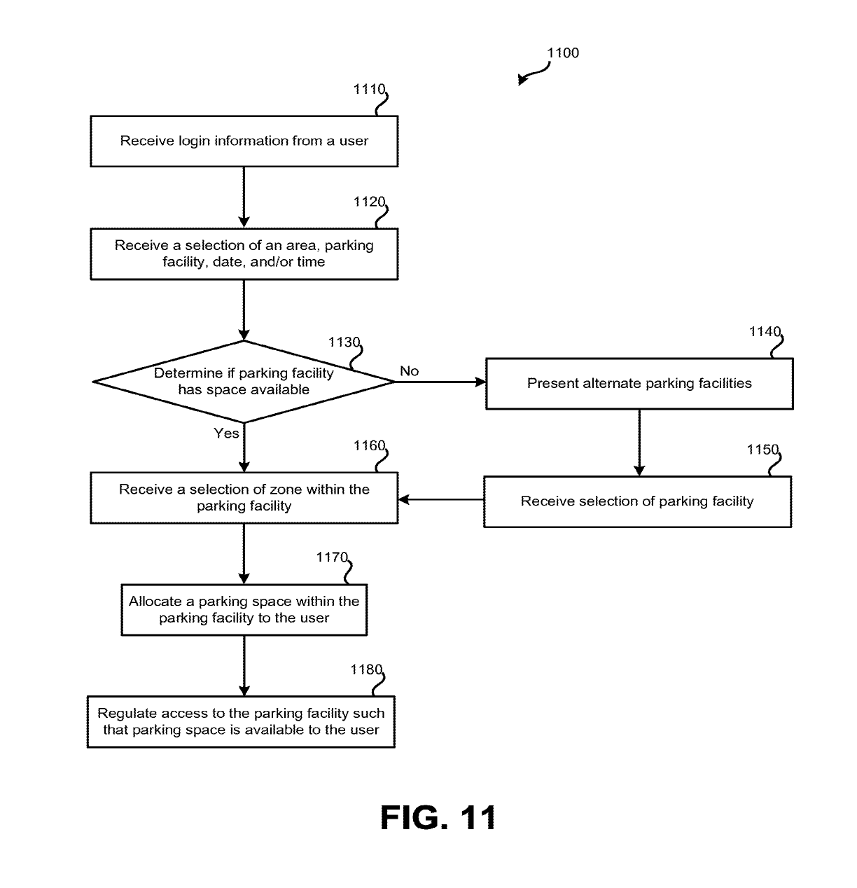

FIG. 11 illustrates an embodiment of a method for reserving a parking space for a user remotely, such as from a remote computer system or a mobile device, such as a cellular phone. Method 1100 may be performed using a parking management system, such as parking management system 100 of FIG. 1 or parking management system 200 of FIG. 2. Some other form of parking management system may also be used to perform method 1100. The user who desires to reserve a parking space may be a day user for the parking facility at which she intends to reserve a parking space. In some embodiments, a lessee may be permitted to reserve a specific parking space at a parking facility where the lessee holds a lease for a parking space remotely.

At stage 1110, login information may be received from a user. As such, a user may have previously established a user account with a parking management server. Login information may include a username and password. In some embodiments, alternative information is presented by the user for login. If a person does not have a user account, a method, such as method 900 of FIG. 9, may be used to create a user account for the person.

At stage 1120, assuming the login information provided by the user is correct, the user may be granted access to her account. A graphical user interface, such as parking system graphical user interface 500 of FIG. 5, may be presented to the user. The user may provide a selection of an area in which the user desires to park and/or a specific parking facility. The user may also provide a date and/or time at which she intends on entering and/or exiting the parking facility. If the parking space is unused for a portion of the reserved time period, the user may or may not be charged associated parking fees.

At stage 1130, the parking server system may determine whether the parking facility (or a parking facility in the area) requested by the user will have space available for the requested date and/or times. If not, the method may proceed to stage 1140. At stage 1140, the user may be presented with alternative parking facilities that are in communication with the parking management server and are near the area or parking facility requested by the user. At stage 1150, the user may select an alternative parking facility from the list or map of facilities presented by the parking management server. Returning to stage 1130, if the parking facility or parking facility within the area is selected by the user and has a parking space available, method 1100 may proceed to stage 1160.

At stage 1160, a selection of a zone within the parking facility may be received from the user. In some embodiments, the user may not have the opportunity to select a zone within the parking facility. If the user is presented an opportunity to select a zone within the parking facility, the user may have the opportunity to select zone such as rooftop parking, surface parking, and unreserved parking and/or reserved parking. The price for each type of parking space may vary. In some embodiments, the user may select a specific parking spot. To select a parking spot or zone, a map of the parking facility may be presented to the user.

At stage 1170, a parking space within the parking facility (and the selected zone) may be allocated to the user. As such, the user may be assured that upon arrival at the parking facility a parking space within the facility and requested zone is available. At stage 1170, parking facility utilization information may also be updated. Since a parking space has been allocated to the user, access to the parking facility may be regulated by the parking management server (at stage 1180) such that a space is held available for the date and time range received from the user. Such regulation may involve denying access to other vehicles to the parking facility despite a parking space being empty (because the space is reserved for the user). For instance, the vehicle may be denied by a gate of an access control system not being raised.

However, upon arrival by the vehicle of the user, the vehicle identifier of the user's vehicle may be used to identify the user account of the user. The user account may reflect that a space within the parking facility has been reserved for the user. If the time and date range at which the user and the user's vehicle is attempting to enter the parking facility at least approximately match, the user and the user's vehicle may be granted access to the parking facility such that the space reserved remotely may be accessed and used by the user. Electronic signage may indicate a parking space number, level, or zone of the parking facility that the user is to proceed to.

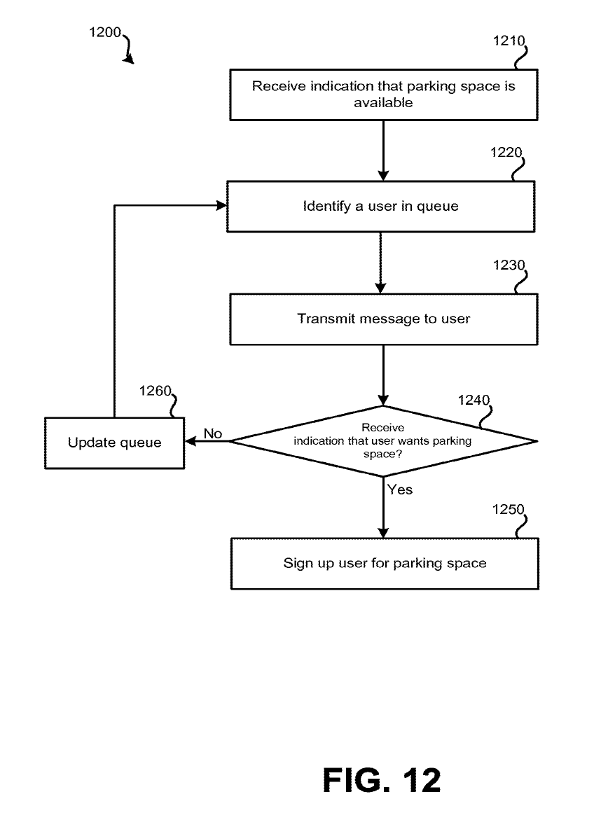

FIG. 12 illustrates an embodiment of providing users in a queue the opportunity to acquire a parking space. Method 1200 may be performed using a parking management system, such as parking management system 100 of FIG. 1 or parking management system 200 of FIG. 2. Some other form of parking management system may also be used to perform method 1200.

Some parking facilities may be expected to have a high demand for leased parking spaces. As such, the number of requests for leased parking spaces may exceed the number of parking spaces available for lease. As such, maintaining a queue such that potential lessees are contacted by the parking management server as parking spaces become available may be beneficial.

At stage 1210, the parking management server may receive an indication that a parking space is available for lease. This may occur if a previous lessee (such as an individual or a group tenant) has terminated or not renewed a lease or the manager of the parking facility has allocated an additional parking space for leasing (such as by decreasing the number of parking spaces allocated for day users).

At stage 1220, a user in a queue may be identified. Previously, a user may have added herself to the queue by attempting to lease a parking space, such as using parking system graphical user interface 400 of FIG. 4. Information provided by the user to enter the queue may include: the user's name, the date the user would like to lease a parking space, and a phone number that accepts text messages. The user that has been in the queue the longest may be identified.

At stage 1230, a message may be transmitted to the user. The message may be in a form such as an email, text message (to a mobile device), or phone call and may be received by the user via a mobile device, computer system, or telephone. The user may have a certain amount of time to respond in the affirmative that the user still desires to lease the parking space. For example, the user may be allowed 48 hours to respond before another user is contacted.

At stage 1240, if the user indicates that the user wants the parking space, the method may proceed to stage 1250 to complete the lease for the parking space by the user. Terms and conditions of the lease may be transmitted to the user, which may require the user's signature. If the user does not want the parking space, the queue may be updated at stage 1260 (such as by removing the user who responded at stage 1240 or by moving the user to the back of the queue). Method 1200 may return to stage 1220 to identify the next user in the queue. Method 1200 may repeat until a user accepts a lease for the parking space.

Typically, pricing within a parking facility is fairly static. A parking facility may charge a day rate (e.g., from 7 AM until 6 PM) and a night and/or weekend rate. Prices for such time periods may be determined based on market rate surveys and empty space counts. The parking facility manager may then manually decide to adjust rates up or down in an attempt to maximize profits. Similar strategies may be employed for determining how to price parking for leases.

In contrast, a parking management system may permit prices to be significantly more variable in reaction to demand and customer interest. Rather than relying on conventional surveys and available parking space counts, pricing can be varied for types of parking spaces and/or specific parking spaces within a parking facility based on multiple factors, which may include: historical usage of types of parking spaces (or specific parking spaces), customer interest in types of parking spaces (or specific parking spaces), and/or characteristics of a particular customer (which may be stored as attributes in a user profile linked with the customer).

The profitability of a parking facility may be significantly improved by tailoring pricing (either on a daily basis, lease basis, or both) to utilization data collected from the parking facility, interest data collected from users, and characteristics of the user purchasing parking. Further, while profitability of the parking facility may be improved, customers may also be provided with a superior product: for customers willing to pay a premium, a highly-desirable parking space may be obtained, and for customers wanting to save money, a parking space that is historically under-utilized and/or inconvenient may be made available for a lower price.

The actual pricing for types of parking spaces within a parking facility and/or specific parking spaces may be determined by a computer system, such as parking management server 110 of FIGS. 1 and 2, without the price needing to be actively set by a human user. Rather, a manager of a parking facility, such as via parking facility management computer system 130, may define a set of rules that governs how the prices for types of parking spaces and/or particular parking spaces within the parking facility are calculated.

A first type of information that may be used to determine the pricing of a type of parking space and/or a particular parking space is historical utilization data. Such utilization data, such as stored in utilization database 150 of FIG. 1, may indicate how a parking facility, type of parking space (e.g., rooftop, reserved, lower-floors) within the parking facility, and/or specific parking spaces have been utilized over a period of time (such as, within the last year or the life of the parking facility).

Utilization data may be gathered in multiple ways. Facility usage data may be based on entries and exits from the parking facility. Usage of types of parking spaces and/or particular parking spaces may be based on leases and/or day use purchases by customers using remote computer systems, such as remote computer system 140 of FIG. 1. For example, the number of customers that rent rooftop parking spaces before arriving at the parking facility may be used to determine an interest level in rooftop parking spaces. Further, if a user inquires about a rooftop parking space but does not rent or lease one, this may still indicate interest in rooftop parking. If a customer leases a parking space, based on an RFID device, license plate number, or some other method of identifying the customer's vehicle, it may be determined when the customer's leased parking space is in use (e.g., occupied by his or her vehicle). Such an arrangement may be effective whether a specific parking space is reserved for the customer or a type of parking space is reserved for the customer. Based on when the vehicle enters and exits the parking facility, utilization of the customer's lease may be determined. As an example, if the user leased a rooftop parking space, when the customer's vehicle enters the parking facility, the utilization of a rooftop parking space may be assumed.

Utilization data may be gathered for particular parking spaces. In some parking facilities, sensors may be present that detect whether or not specific parking spaces are in use or empty. For example, pressure sensors or magnetic sensors may be used. Cameras may be used to record when a vehicle enters and exits a zone (e.g., a level, restricted area) in the parking facility and to determine the parking space that is occupied by the vehicle. If a customer has a specific reserved parking space, it may be determined when this parking space is in use based on the customer's entry and exit from the parking facility (in such embodiments, sensors that detect a vehicle within particular parking spaces may not be necessary).

Regardless of the method and what types of utilization and interest data is collected, the collected data may be frequently updated such that the utilization data accurately reflects the current utilization of the parking facility, types of parking spaces within the parking facility, and/or specific parking spaces within the parking facility. As such, the utilization data for a parking facility may be continually (e.g., in real time or near real time) or periodically updated (e.g., once per day, once per week) without requiring input from a parking facility manager. Such utilization data may be gathered for one or more parking facilities (such as using data from parking facility access systems 120) by parking management server 110 and stored as part of utilization database 150. Further, data that is pertinent to particular users may be used to update user profiles stored in user profile database 160.

A second type of information that may be used to determine the pricing of a type of parking space and/or a particular parking space is customer (user) interest. Customer interest may refer to how frequent (compared to other parking spaces) customers have inquired about and/or purchased a particular parking space or a type of parking space. If a customer is renting a particular parking space or a type of parking space for a day or leasing for a longer period of time, the customer may inquire (such as from a remote computer system) as to the cost and/or availability of a particular parking spot. For example, a parking space on the ground floor close to an office entrance may be significantly more desirable than a parking space located away from an office entrance. By tracking how often customers inquire about a particular parking space or type of parking space—whether or not the parking space is available or is purchased—an amount of interest in the parking space can be measured and pricing may be adjusted accordingly.

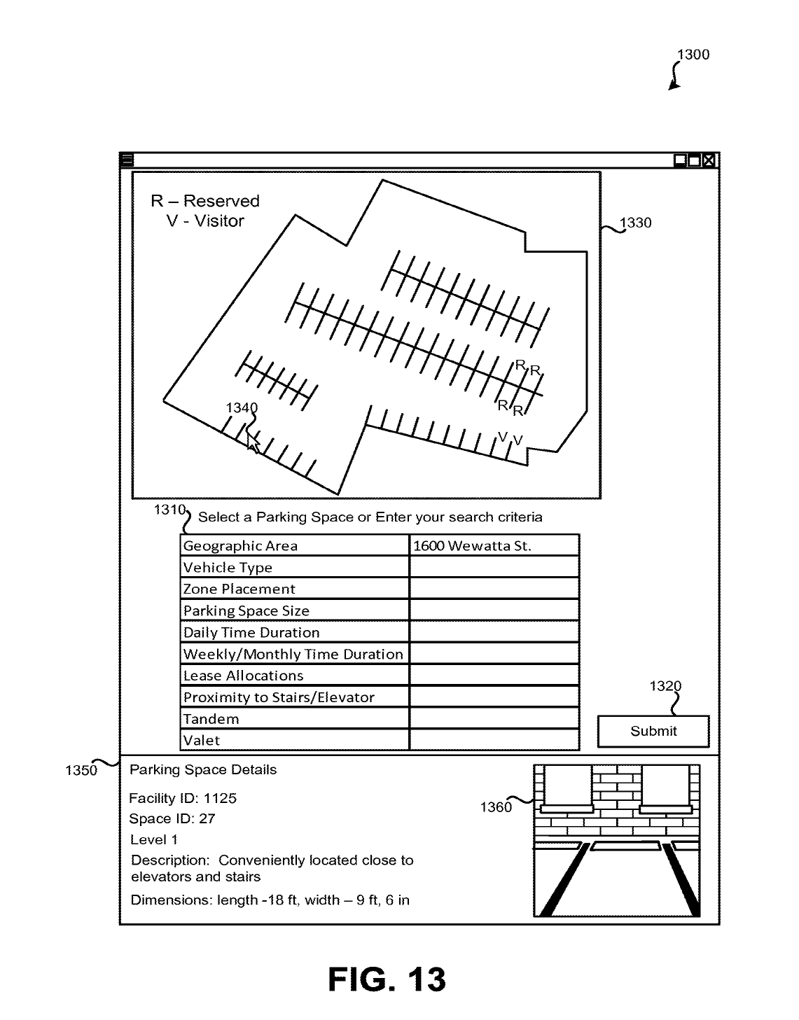

FIG. 13 illustrates an embodiment of a user interface 1300 that may permit a customer to select a parking space (or type of parking space) for day use or lease. (As such, user interface 1300 may be an alternate embodiment to parking system graphical user interface 500 of FIG. 5.) When a user desires to rent (e.g., for a short period of time, such as a day) or lease (e.g., for a month or year) a parking space, user interface 1300 may be presented to the customer. Referring to FIG. 1, user interface 1300 may be presented on remote computer system 140 based on information originating from parking management server 110. A user interface, such as user interface 1300, may provide a user with an opportunity to search for a particular type of parking space and/or select a particular parking space.

Search criteria 1310 may permit a user to specify criteria for a parking search. For example, if the customer already has a parking facility in mind (such as one near his or her office), the “geographic area” field may be used to specify the specific location of the parking facility. Additional search criteria may be provided by the customer, such as: vehicle type (e.g., motorcycle, compact car, oversize SUV), zone placement (e.g., ground floor, rooftop), parking space size (e.g., at least 10 ft. wide), daily time duration (e.g., the space is needed from 9 AM to 6 PM), weekly time duration (e.g., Monday through Thursdays), monthly time duration (e.g., each week of the month, only the first week of the month), lease allocations (e.g., a corporate tenant that has rights to a number of parking spaces), proximity to stairs/elevator/egress points (e.g., 50 ft. or less), tandem (e.g., a parking space for two vehicles, where one of the vehicles is blocked by the other), and valet (e.g., a person parks for you). Additional or different search categories may also be possible.

A customer may be permitted to enter search criteria and submit the search criteria via input interface 1320. An available parking space that matches the customer's criteria may be returned. The search criteria submitted by the user may be used to determine customer interest in types of parking spaces that match the user's criteria. For example, if customers are searching for tandem parking, it may be an indication that this type of parking is desirable.

In some embodiments, the search criteria may be used to highlight on a map of a parking facility 1330 which parking spaces meet the user's submitted search criteria. From among the highlighted parking spaces, the user may be permitted to select a particular parking space for inquiry about day use or lease. All of the parking spaces highlighted on the map of the parking facility 1330 may or may not be available. It may be useful to highlight parking spaces that are not currently available to be able to gather interest data about which parking spaces customers select. If a user selects a currently unavailable parking space (or type of parking space), a similar parking space that shares characteristics with the selected parking space but is available may be presented to the user. If the user still wants the unavailable parking space, the user may place himself in a waiting list queue for that particular parking space. Alternatively, the user may save an indication of the particular parking space is the user's “favorites” under his user account for possible use in the future (e.g., when the space becomes available).

In some embodiments, rather than a customer entering search criteria, the customer may select a desired parking space from the map of the parking facility 1330. Referring to FIG. 13, a customer may use cursor 1340 to select a particular, desired parking space. Such an inquiry into a particular parking space may be used to determine an amount of interest in the particular parking space and/or parking spaces of the same type. If a customer selects a particular parking space that is unavailable, another parking space having similar characteristics may be recommended instead. Such an alternate parking space may be as close as possible to the initially selected parking space.

Parking space details window 1350 may be displayed to the customer. This window may provide details on a type of parking space or a particular parking space, such as a parking space selected by the customer via map of the parking facility 1330, via a search conducted via search criteria 1310, or by a recommendation made to the customer. The parking space details window may indicate various characteristics (or attributes) of the parking space to the customer, such as the location (e.g., address), the facility ID (e.g., the name or identifier of the parking facility), a parking space identifier, a level (e.g., which floor of the parking facility), a description, and dimensions. A photograph 1360 of the parking space may be presented to the customer.

Some or all information provided by a customer via user interface 1300 may be used to determine an interest level in a parking facility, a type of parking space, and/or a particular parking space. A database of interest data 170 may be maintained, such as by parking management server 110. Whenever a customer provides input to user interface 1300, this information may be logged within interest database 170. As such, entries may be maintained within interest database 170 for a particular parking space, a type of parking space and/or a parking facility. Interest information may be maintained for when a customer submits search criteria. Such information may be indicative of interest in parking spaces that match some or all of the search criteria. Interest information may be collected when a customer selects a parking facility, particular parking space, and/or type of parking space. Such information may be independent of whether the parking space is available or is purchased by the customer.

It should be understood that user interface 1300 is only an exemplary embodiment. Other embodiments of the user interface may be rearranged, may present more or less information, and may permit more or less user interaction.

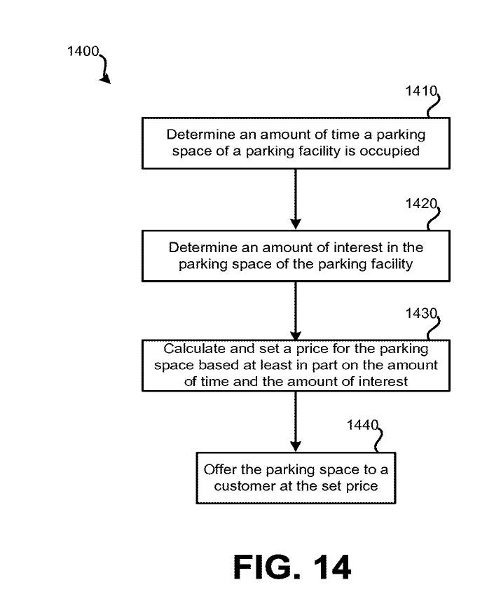

FIG. 14 illustrates an embodiment of a method 1400 for offering vehicle parking. Method 1400 may be performed using a parking management system, such as parking management system 100 of FIG. 1 or parking management system 200 of FIG. 2. Some other form of parking management system may also be used to perform method 1400. A computerized device, such as a computer system, may be used to perform method 1400. It should be understood that while method 1400 is directed to a particular parking space of a parking facility, method 1400 may be generally applied to an entire parking facility, a type of parking space (either at a single parking facility or across multiple parking facilities), and/or to some or all of the individual parking spaces present in a parking facility.

At step 1410, an amount of time a particular parking space of a parking facility, such as a parking garage, is occupied is determined. This time may be tracked as utilization data. The amount of time the particular parking space is occupied may be based on sensor measurements that detect whether the particular parking space has a vehicle parked in it. The amount of time the particular parking space is occupied may also be based on the amount of time customers have reserved the particular parking space, such as via user interface 1300 of FIG. 13. If the parking space is a leased parking space, entries and exits from the parking facility by the customer that has leased the parking space may be used to determine whether the parking space is occupied or vacant.

At step 1420, an amount of interest in the parking space may be determined. The amount of interest in the parking space may be determined based on customer (user) actions (either of a specific customer or multiple customers) involving the parking space or the type of parking of the parking space. A database or other data storage arrangement may be maintained that contains information on the amount of interest expressed by one or more customers in the parking space. The amount of interest may be based on information such as: a number of search requests made that match the parking space (e.g., via search criteria 1310 of FIG. 13) and/or a number of selections of the particular parking space (e.g., via map of the parking facility 1330 of FIG. 13). Such data may indicate how often the parking space was only inquired about and how often the parking space was inquired about and purchased. The amount of interest may also factor in the duration of time a vehicle tends to remain in the parking space when rented or leased.

At step 1430, a price may be calculated and set for the parking space based at least in part on the amount of time the particular parking space of the parking facility is occupied and the amount of interest in the parking space determined at step 1420. Additionally, a set of rules, possibly defined by the parking facility's administrator, may govern how the amount of time of step 1410 and the amount of interest of step 1420 affect the pricing of the parking space. For example, table 1 defines a set of exemplary rules that may be used by step 1430.

TABLE 1

| | |
|---|---|
| Maximum price | $5/hr |
| Minimum price | $3/hr |
| Maximum frequency of rate change | 2/day |
| Weighting of utilization data | .7 |
| Weighting of interest data | .3 |
| Match neighboring parking spaces | No |
| Set maximum stay time? | Yes - 10 hrs |

The rules of Table 1 are only for example purposes only and it should be understood that greater, fewer, and/or different rules may be used in other embodiments. In step 1430, such rules may be used in conjunction with the data determined at steps 1410 and 1420. The maximum price may refer to a maximum amount that the parking facility administrator currently wants to charge for either a particular parking space, any parking space at the facility, or a type of parking space, the minimum price may refer to the minimum amount the parking facility administrator currently wants to charge, the maximum frequency may refer to how often the parking facility management system is permitted to vary the pricing of the parking space, the weighting numbers may determine the relative importance of the utilization data to the interest data, whether the pricing is required to match neighboring spaces may be useful so that the parking facility maintains a group of similarly priced parking spaces together, and, finally, a maximum time may be set that a customer is permitted to stay at the determined rate.

At step 1440, the parking space may be offered for leasing or a daily rental (or some other period of time) to a customer at the price set at step 1430. The parking space may be offered to the customer via a user interface such as user interface 1300 of FIG. 13. The customer, via the offer, may be permitted to accept the price and retain the rights to use the parking space or may decline the offer. If declined, an alternate parking space (possibly at a different price) may be offered to the user. For example, if the parking space is expensive, the customer may be likely to accept a less expensive (but possibly less desirable, according to utilization and interest data) parking space. Besides user interface 1300, an offer of the parking space may be made upon entry to a parking facility, such as before a gate is raised and the driver is permitted entry to the parking facility.

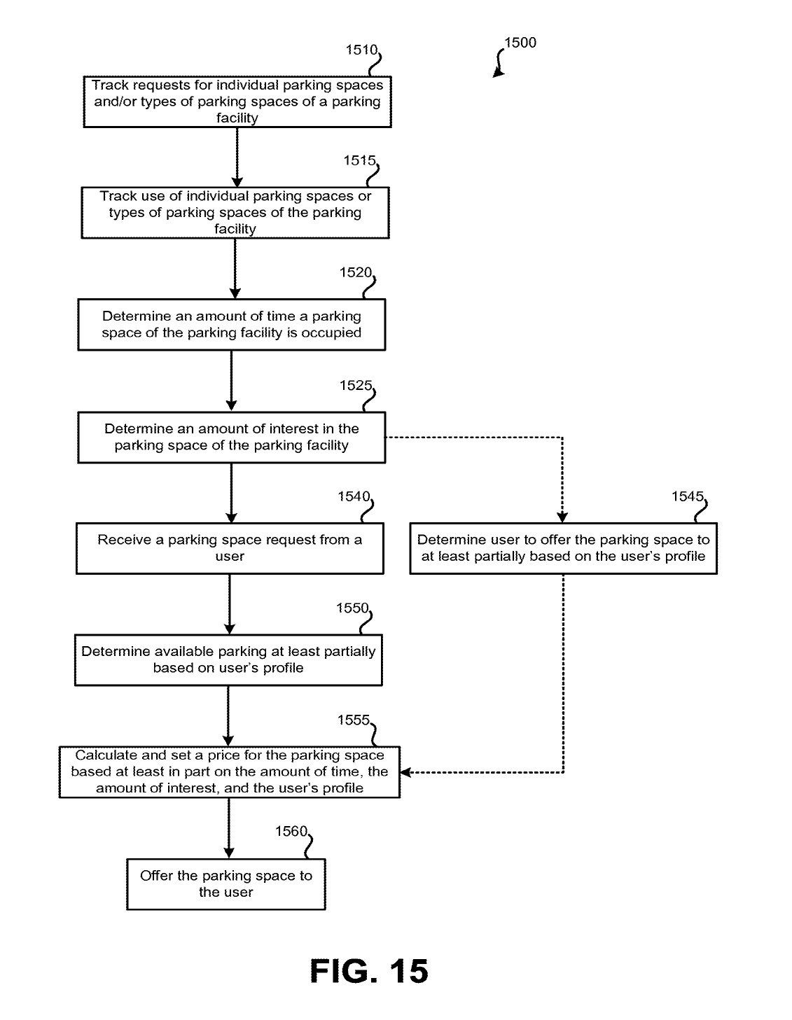

FIG. 15 illustrates an embodiment of a method 1500 for offering vehicle parking. Method 1500 may be performed using a parking management system, such as parking management system 100 of FIG. 1 or parking management system 200 of FIG. 2. Some other form of parking management system may also be used to perform method 1500. A computerized device, such as a computer system, may be used to perform method 1500. It should be understood that while method 1500 is directed to a particular parking space of a parking facility, method 1500 may be generally applied to an entire parking facility, a type of parking space (either at a single parking facility or across multiple parking facilities), and/or to some or all of the individual parking spaces present in a parking facility.

At step 1510, requests (which result in rentals or leases) and inquiries (which do not necessarily result in rentals or leases) may be tracked and stored. This information may be stored for individual parking spaces, types of parking spaces (within a parking facility and/or across multiple parking facilities), and/or parking facilities. This information may be used to determine an amount of interest in parking spaces. This information may be gathered via user interface 1300 when a user remotely rents, leases, searches for, or inquires about parking spaces.

At step 1515, utilization data of individual parking spaces, types of parking spaces (within a parking facility and/or across multiple parking facilities), and/or parking facilities may be tracked and stored. This information may be based on parking spaces rented or leased (for example, via user interface 1300 of FIG. 13) and the amount of time the parking spaces are rented or leased for. Tracking of vehicles entering and exiting a parking facility (which may be cross-referenced with which parking space or type of parking space the customer operating the vehicle has rented or leased) and/or sensors that track occupancy of a particular parking space may also be used in determining the utilization data and/or parking violations.

At step 1520, an amount of time a particular parking space of a parking facility, such as a parking garage, is occupied may be determined. This determination may be based on the data tracked at step 1515. This time may be referred to as utilization data. Utilization data may be averaged for a time period, such as a day, week, month, year, etc. At step 1525, an amount of interest in the parking space may be determined using the data tracked at step 1510. The interest data may weight inquiries against requests according to a parking facility administrator defined ratio. A database or other data storage arrangement may be maintained that contains information on the amount of interest expressed by one or more customers in the parking space. The amount of interest may also factor in the duration of time a vehicle tends to remain in the parking space when rented or leased.

At step 1540, a request may be received from a user, such as via user interface 1300 of FIG. 13 presented to the customer via a remote computer system. The request may be received by parking management server 110 of FIG. 1 from a remote computer system, such as remote computer system 140. An identifier of the user may be included. If the user has a user account (or user profile), the user account may be accessed. A user profile may maintain details about the user. For example, the user profile, which may be part of a user account or other data stored about the user, may contain information sufficient to identify the user, the user's vehicle, and a priority level of the user. Generally, parking managers have access to set up all profiles for owners, buildings, management entities, facility locations, leases, group accounts, and individual user accounts. Users have access to set up user accounts and group accounts.

User's have access to set up individual and Group account and link parking space selection to the account.

A parking facility manager may desire to give certain customers priority over other customers. As an example, if a parking facility is attached to an office building, the parking facility manager may desire to give office tenants first choice on parking spaces (and/or types of parking spaces) or access to particular reserved parking spaces. As another example, the parking facility manager may increase a priority level in a user's profile to appease certain particularly important customers: if a parking facility is attached to an office building, resident businesses' CEOs and managing partners may be given first choice on parking spaces and/or access to certain reserved parking spaces. The parking facility manager may be able to configure multiple priority levels and order customers as desired. Table 2 illustrates an example of users' profiles (which may be part of user accounts).

TABLE 2

| | License | | | Priority |
|---|---|---|---|---|
| Name | Plate # | Access Level | Start Date | Level |
| Bill Hogan | 986 MZH | C-Executive | Apr. 27, 1981 | Level 1A |
| Peter Joseph | GO27278 | Administrative | Jun. 13, 2007 | Level 3 |

Table 2 contains an exemplary selection of data which may be present in a user profile. The priority level of users may be used to determine: which parking spaces they are permitted to rent and/or lease, an order in which parking spaces is offered to the user, and/or a price of the parking space. Regarding price, a high executive level customer may be quoted a higher price than an administrative employee because it is expected they have more disposable funds and are more likely to agree to a higher price. The converse may also be true, high ranking customers may be quoted a lower price in order to keep them appeased with the parking facility and continue occupying an attached office complex.

At step 1550, the user profile of the user from whom the request was received is used to determine what parking is available for rent or lease. This may involve access to particular parking reserved for building tenants and/or high (or low) ranking customers. At step 1555, a price may be calculated and set for the parking space based at least in part on the amount of time the particular parking space of the parking facility is occupied, the amount of interest in the parking space determined at steps 1520 and 1525, respectively, and the user's profile. Additionally, a set of rules, similar to Table 1 and described in relation to method 1400 may govern how the amount of time and the amount of interest affect the pricing of the parking space. The rules set by the parking facility administrator may determine how the user's priority level and/or access level affects pricing. As such, the calculated price may be at least partially based on the user's priority level and/or access level.

Rather than receiving a request from a user at step 1540, the parking space may be offered to a particular user at least partially based on the user's priority level at step 1545. Therefore, if a desirable parking space becomes available, it may first be offered to users having a high priority level and/or access level. Such users may be users that have indicated they desire to rent or lease a parking space. The first user the parking space is offered to may be contacted via email, text, phone, etc., and may be offered the opportunity to rent or lease the parking space. The pricing offered each user may vary based on each user's profile. A user's inquiries and requests for parking may affect pricing. For instance, if a user inquired about a particular parking space several times, it may be assumed the user is interested in the parking space. Additionally, if a user is known to use the parking facility infrequently, a lower price may be quoted (because the parking space may be re-leased or rented in the evening or weekends). Conversely, if the parking space is expected to be used very frequently by the user, a higher price may be calculated at step 1555.

At step 1560, the parking space may be offered for leasing or a daily rental (or some other period of time) to a customer at the price set at step 1555. The parking space may be offered to the customer via a user interface such as user interface 1300 of FIG. 13. The customer, via the offer, may be permitted to accept the price and retain the rights to use the parking space or may decline the offer. If declined, an alternate parking space (possibly at a different price) may be offered to the user. The user may be permitted to save spaces to the user's profile. For example, if the parking space is expensive, the customer may be likely to accept a less expensive (but possibly less desirable, according to utilization and interest data) parking space. Besides user interface 1300, an offer of the parking space may be made upon entry to a parking facility, such as before a gate is raised and the driver is permitted entry to the parking facility.

If the parking space is offered to another user, the priority level of users desiring a parking space may be used to determine who the parking space is next offered to. As such, desirable parking spaces may first be offered to user with a high priority level (and/or access level). If a user is offered a parking space before other users, the price may be increased to reflect the opportunity of being permitted an earlier opportunity to rent or lease the parking space.

FIG. 16 illustrates an embodiment of a method 1600 for using profiles to manage a parking facility. Use of profiles may allow for information regarding parking facilities, owners, parking management entities, tenants, group accounts, users, and buildings to be stored as profiles that can be linked to establish relationships and/or enable parking rights. In method 1600, a profile for a parking facility is linked with a profile for an owner of the parking facility. Method 1600 may be performed using a parking management system, such as parking management system 100 of FIG. 1 or parking management system 200 of FIG. 2. Some other form of parking management system may also be used to perform method 1600. A computerized device, such as a computer system, may be used to perform method 1600.

At step 1610, a profile for a parking facility may be created and stored. Creating a profile for a parking facility may involve characteristics specific to parking facilities being provided to the parking management server of the parking management system by a manager. As such, step 1610 may involve a parking manager inputting data about the new parking facility. Referring to FIG. 1, the manager may use parking facility management system 130 to provide information to parking management server 110. If a profile has previously been created for the parking facility, the creation of a new profile for the parking facility may not be necessary. Rather, the previously created profile for the parking facility may be used. Table 3 indicates examples of data fields for which information may be provided by a manager for a parking facility in a parking facility profile.

TABLE 3

| Parking Facility Profile Fields | Details/Selection Options |
|---|---|
| Location Name | |
| Location Facility Code | (A code assigned to a parking facility for use |
| | in processing, billing, and tracking use of the |
| | parking facility in conjunction with user |
| | accounts) |
| Location Address | Street, City, State, Zip Code |
| Type of Parking Location | Office Building, Surface Lot, Mix-Use |
| | Facility, Hotel, Hospital, University/College, |
| | Retail, Stadium, Airport, Ski Resort, Sports |
| | Arena, Residential |
| Status | Active/Inactive |
| Clearance | (Max Height in feet, inches) |
| Self Parking | Yes/No |
| Total Number of Parking Spaces | |
| Handicap Spaces Required | (May be automatically calculated based on |
| | total number of parking spaces) |
| Number of Handicapped Parking Spaces | |
| Number of Levels | |
| Bicycle Parking | Yes/No |
| Number of Bicycle Racks | |
| Type of Bicycle Racks | Wave, J-frame, A-frame, double-sided, |
| | single-sided, floor mount, wall mount, |
| | double-decker, etc. |
| Bicycle Storage | Yes/No |
| Number of Bicycle Storage Units | |
| Motorcycle/Scooter Parking | Yes/No |
| Valet Parking | Yes/No |
| Valet Type | |
| Garage Layout | Upload Image File |
| Garage Rules | Upload Rules |
| Garage Amenities | Jump Start, Tire Inflation, Car Wash/Detail, |
| | Windshield Replacement/Repair, Car Care |
| | (Oil, Tire Rotation), Books to Go, Dry |
| | Cleaner, Pedi-Cab |

Only some of the data fields detailed in Table 3 may be required for a profile for a parking facility; other fields may be optional. Further, in other embodiments, additional, fewer, or different data fields may be present within a profile for a parking facility. The parking facility profile created at step 1610 may be stored by the parking management system. At least some of the data fields of Table 3 may be specific to parking facilities; such fields may not be available in profiles for other types of entities.

Additionally, the profile of a parking facility may contain pricing information. A parking manager may control the prices available at a parking facility by editing the profile of the parking facility and adjusting a listing of prices. The parking manager may be able to set different prices for users associated with tenants (e.g., entities that rent or own space in a building associated with the parking facility), users not associated with tenants, and reserved and unreserved parking spaces. The prices may be set to vary by date, time, and/or occupancy of the parking facility. For example, tenant customers visiting a parking facility may be given a set rate of $2.00 for every fifteen minutes, while non-tenant daily customers may have a set rate of $2.00 every ten minutes. Such a discount may be issued in the form of a credit transferred from the tenant group account to the user account. Or, in some embodiments, rather than a discount, a value transfer may occur to the user account from an account of the tenant. In some embodiments, a building tenant may be permitted to purchase parking at a discounted rate than individual users.

Further, a manager may provide indications of each parking space available within the parking facility to a parking facility profile. In some embodiments, this may simply be a count of the parking spaces of various types available at the parking facility. In some embodiments, specific information may be input and stored for some or all parking spaces of the parking facility, such as a unique identifier (which is unique among all of the parking spaces at the parking facility), parking space dimensions, clearance level, whether self-parking is available, whether valet parking is available, the level of the parking space, and/or the parking space classification (e.g., reserved, non-reserved, handicapped). An image of the parking space may be stored. Characteristics of parking spaces provided by the manager may be applied to multiple parking spaces (for example, the clearance may be the same for all parking spaces in a parking facility). Individual parking spaces may be added (for example, the lines within the parking facility are repainted to accommodate additional parking spaces) or subtracted (for example, a parking space may be eliminated from the system because it has been dedicated to storage) from the profile of the parking facility. The parking manager may be permitted to add and/or subtract parking spaces from a parking facility as necessary. The profile of the parking facility may be used for multiple purposes. For example, information from the profile of the parking facility may be used to provide a user with the prices, map, location, and other locations of parking facilities when the user accesses the parking management system via parking system graphical user interface 500.

At step 1620, a profile for an owner of the parking facility may be created and stored. Creating a profile for an owner may involve a manager providing characteristics specific to the owner. As such, step 1620 may involve a manager inputting data about the owner to the parking management server of the parking management system. Referring to FIG. 1, the manager may use parking facility management system 130 to provide information to parking management server 110. Table 4 indicates data that may be provided by a manager regarding an owner. If a profile has previously been created for the owner, the creation of a new profile for the owner may not be necessary. Rather, the previously created profile may be used.

TABLE 4

| Owner Profile Fields | Details/Selection Options |
|---|---|
| Company Name | |
| Company Address | Street, City, State, Zip Code |
| Company Contact | Phone Number, Fax Number, Email Address, |
| Numbers | Website |
| Primary Owner | Name, Phone Number, Fax Number, Email |
| | Address, Website |
| Secondary Owner | Phone Number, Fax Number, Email Address, |
| | Website |
| Additional Contact | Phone Number, Fax Number, Email Address, |
| | Website |
| Contract Terms with the | |
| Parking Management | |
| Entity | |
| Effective Date of | |
| Ownership | |
| Termination Date of | |
| Ownership | |
| Owner Code | Unique identifier assigned to owner |

Only some of the fields detailed in Table 4 may be required for a profile for an owner; other fields may be optional. Further, in other embodiments, additional, fewer, or different fields may be present within a profile for an owner of a parking facility. The owner profile created at step 1620 may be stored by the parking management system.

At step 1630, input may be received (such as from a manager using the parking management system) that indicates the owner whose profile was created at step 1620 is to be linked with the parking facility of the profile created at step 1610. This input may involve the owner's profile being selected (e.g., from a drop down list of all available owners) within the parking facility's profile. In some embodiments, the profile of the parking facility may be selected (e.g., from a drop down list of all available parking facilities) within the owner's profile. At step 1640, the profiles may be linked and the relationship may be stored. As such, this link between the two profiles may indicate that the owner owns the parking facility. If the owner owns additional parking facilities, profiles of these additional parking facilities may also be linked with the profile of the owner. Without the link, the owner's profile and the parking facility's profile may remain independent.

By having a profile of the owner linked with a profile of the parking facility, it may be possible to perform functions with the parking management system involving multiple parking facilities. For example, rather than determining usage data or statistics about a single parking facility, such usage data may be generated for all parking facilities linked with the owner's profile. As such, an owner may be provided with a report containing usage data for both individual parking facilities and all of the owner's parking facilities managed using the parking management system. At step 1650, such a report may be generated that contains usage data across the parking facility linked with the owner at step 1640 and, if present, additional parking facilities linked with the owner's profile.

If a parking facility is sold or otherwise changes ownership, the link between the profile of the parking facility and the owner can be modified to indicate the change. For example, a different owner profile may be linked with the profile of the parking facility. As such, when reports are generated about the parking facility, the newly linked parking facility may be included in the reports. Further, if information about a particular owner changes (e.g., a new address), the owner's profile may be modified, without requiring owner information to be updated for each individual parking facility owned by the owner.

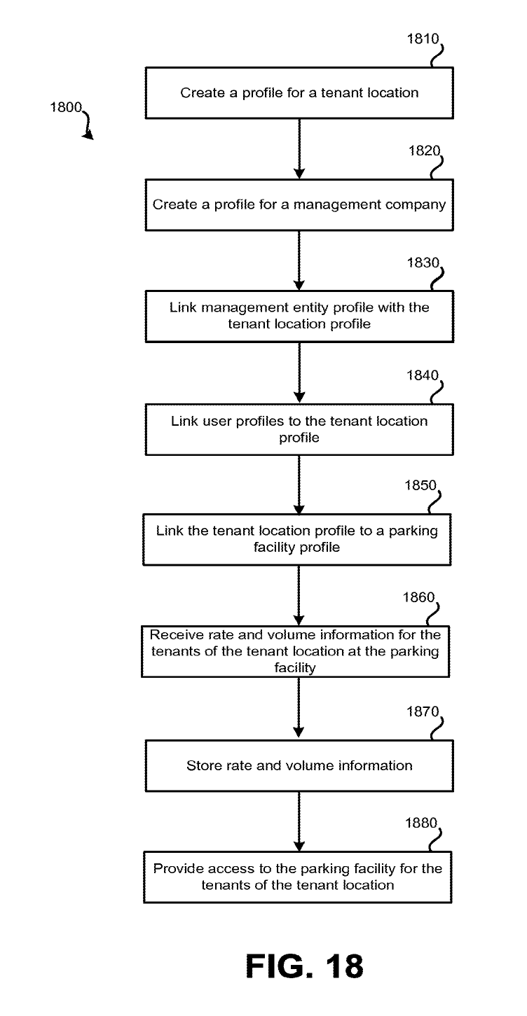

An owner profile may be linked with a tenant location profile at step 1650. A profile for a tenant location, such as an office building, may be created (such as in step 1810 of method 1800 of FIG. 18). An owner profile may be linked to a tenant location profile before the owner is linked with a parking facility. Therefore, by an owner profile being linked with a tenant location that is, in turn, linked to a parking facility, the owner profile is linked to the parking facility. If a detached parking facility is used for a tenant location, the owner of the tenant location may be different than the owner of the parking facility. As such, by being able to link a parking facility and an owner and separately link an owner to a tenant location, links to the proper owner for each type of location can be established. If an owner's profile is not linked directly to a parking facility, by default the owner of a tenant location linked with the parking facility may be treated as the owner of the parking facility.

As an example, an owner profile may be linked to a tenant location and the profile of the tenant location may be linked to parking facilities that are owned by the owner and are attached or detached from the tenant location. If no tenant location is associated with a parking facility, the owner's profile may be linked directly to the profile of the parking facilities owned by the owner. By a profile of an owner being linked with a profile of a tenant location, the owner may be permitted to view relevant leasing information of tenants of the tenant location. By the profile of the owner being linked with a profile of a parking facility, the owner may be permitted to view parking inventory and/or utilization information, as discussed below.

As an example, a parking manager may link a profile of an owner with a profile of an apartment building and a profile of a parking facility with the profile of the apartment building. Profiles of a management company may also be linked to each of these assets. A renter of the apartments may be able to search for parking spaces that have lease agreements attached to them. For example, this could involve parking facilities that are and are not linked with the owner's profile.

At step 1670, input from an owner (or a representative of the owner) may be received requesting information on parking facility utilization and/or revenue. Such a request may be for past, present, and/or future utilization and/or pricing projections. The input may be a request for a particular parking facility that is linked with the owner's profile or for multiple (e.g., all) parking facilities linked with the owner's profile.

At step 1680, a report may be generated and sent to the owner that contains the past and/or present parking facility utilization and/or revenue numbers and/or future parking facility utilization and/or revenue projections. The report may be broken down by parking facilities that are linked with the owner's profile and/or may provide totals across all parking facilities linked with the owner's profile. The report may also be broken down based on individual and group leases. Projections for revenue and utilization rates for daily parkers may also be included.

Leases, which may be stored in conjunction with individual user accounts and group accounts may contain primary rate table information and secondary rate table information. The primary rate table information may indicate the pricing that is currently in effect under the lease, while the secondary rate table information may indicate rates that are effective over some other time period, such as over the next year. In addition to having a primary and secondary rate table, additional rate tables (such as for further into the future) may be stored in relation to a user accounts and group accounts.

When future projections for parking utilization and revenue are desired by the owner, the owner may be required to provide a date or date range. The date or date range may be used to examine lease data stored in conjunction with parking facility profiles linked with the owner's profile, group account profiles (linked with those parking facilities) and individual user profiles (linked with those parking facilities). For the date or date range provided by the owner, it may be possible to determine which leases (both for individual users and group accounts) will be in effect at the requested date and/or date range. In some situations, the rates charged under particular leases may be different at the date requested by the owner than at present rates. The report created may handle this by determining the rates that will be effective at the date or date range requested. For example, this may involve pricing and utilization information be derived from secondary rate tables that have not yet become effective for individual leases or group accounts but that will be in effect at the date or date range requested. Since the effective dates of primary and secondary rate tables may vary be lease, based on the date provided revenue may be projected using the primary rate table for some leases while other leases will require use of the secondary rate table. Based on the effective dates of leases and based on the primary and secondary rate table information stored for leases through individual and/or group accounts, a utilization and/or revenue projection may be determined for one, multiple, or all parking facilities linked with the owner's profile. Utilization and revenue projections may also be broken down based on group account leases and individual user leases. A report that includes past, present, or future projections for utilization and revenue may be provided to the owner on a periodic basis, such as monthly, or whenever requested by the owner.

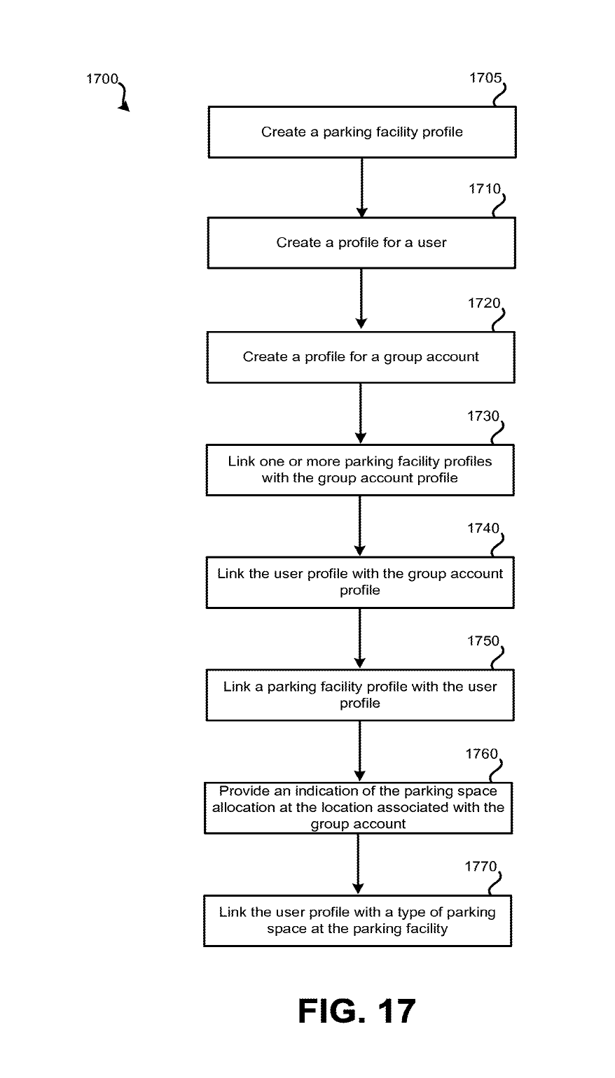

FIG. 17 illustrates an embodiment of a method 1700 for using profiles to manage a parking facility. Use of profiles may also allow for information regarding specific users and group accounts to be managed for parking facilities. As such, accounts for users and group accounts do not need to be recreated for each parking facility. Rather, links between profiles may be adjusted to reflect which parking facilities users and group accounts are associated with. In method 1700, a profile for a parking facility is linked with a profile of a group account, which is linked with at least one user. Method 1700 may be performed using a parking management system, such as parking management system 100 of FIG. 1 or parking management system 200 of FIG. 2. Some other form of parking management system may also be used to perform method 1700. A computerized device, such as a computer system, may be used to perform method 1700.

At step 1705, a profile for a parking facility may be created and stored. Profiles for parking facilities may be created by a parking manager. Creating a profile for a parking facility may involve characteristics specific to parking facilities being provided to the parking management server of the parking management system by a manager. Referring to FIG. 1, the manager may use parking facility management system 130 to provide information to parking management server 110. If a profile has previously been created for the parking facility, the creation of a new profile for the parking facility may not be necessary. Rather, the previously created profile for the parking facility may be used. Table 3, as previously described, indicates examples of data fields for which information may be provided by a manager for a parking facility in a parking facility profile.

Only some of the data fields detailed in Table 3 may be required for a profile for a parking facility; other fields may be optional. Further, in other embodiments, additional, fewer, or different data fields may be present within a profile for a parking facility. The parking facility profile created at step 1705 may be stored by the parking management system. At least some of the data fields of Table 3 may be specific to parking facilities; such fields may not be available in profiles for other types of entities.

The profile of a parking facility may or may not contain pricing information. For example, the profile of a parking facility may contain market rate information, other profiles such as a lease information or a group profile may contain discount data that results in a lower rate for parkers within the parking facility. A parking manager may control the prices available at a parking facility by editing the profile of the parking facility and adjusting a listing of prices, such prices may affect daily users but not users that are linked with a group account that is linked with the parking facility. The parking manager may also be able to set different prices for users associated with tenants (e.g., entities that rent or own space in a building associated with the parking facility), users not associated with tenants, and reserved and unreserved parking spaces. The prices may be set to vary by date, time, and/or occupancy of the parking facility. For example, tenant customers visiting a parking facility may be given a set rate of $2.00 for every fifteen minutes, while non-tenant daily customers may have a set rate of $2.00 every ten minutes. Such a discount may be issued in the form of a credit transferred from the tenant group account to the user account. Or, in some embodiments, rather than a discount, a value transfer may occur to the user account from an account of the tenant. In some embodiments, a building tenant may be permitted to purchase parking at a discounted rate than individual users.

Further, a manager may provide indications of each parking space available within the parking facility to a parking facility profile. In some embodiments, this may simply be a count of the parking spaces of various types available at the parking facility. In some embodiments, specific information may be input and stored for some or all parking spaces of the parking facility, such as a unique identifier (which is unique among all of the parking spaces at the parking facility), parking space dimensions, clearance level, whether self-parking is available, whether valet parking is available, the level of the parking space, and/or the parking space classification (e.g., reserved, non-reserved, handicapped). An image of the parking space may be stored. Characteristics of parking spaces provided by the manager may be applied to multiple parking spaces (for example, the clearance may be the same for all parking spaces in a parking facility). Individual parking spaces may be added (for example, the lines within the parking facility are repainted to accommodate additional parking spaces) or subtracted (for example, a parking space may be eliminated from the system because it has been dedicated to storage) from the profile of the parking facility. The parking manager may be permitted to add and/or subtract parking spaces from a parking facility as necessary. For example, a parking space may be removed so that it is not available for use by parkers.

At step 1710, a profile may be created for a user. In method 1700, a user refers to a person that may or may not be associated with a group account and will park a vehicle in a parking facility. Creating a profile for a user may involve characteristics specific to the user being provided by a manager (or being provided by the user). As such, step 1710 may involve a manager or user imputing data about the user and the user's vehicle(s). In some embodiments, a user may create his or her own user profile. Referring to FIG. 1, the manager may use parking facility management system 130 to provide information to parking management server 110. The user may use remote computer system 140 to provide such information. If a profile has previously been created for the user, the creation of a new profile for the user may not be necessary. Rather, the previously created profile may be used. Table 5 indicates data that may be provided by a manager or user regarding the user and user's vehicle(s).

TABLE 5

| User Profile Fields | Details/Selection Options |
|---|---|
| User Name | First, Last |
| Work Address | Street, City, State, Zip Code |
| Home Address | Street, City, State, Zip Code |
| Contact Information | Home Phone Number, Work Phone |
| | Number, Work Phone Extension Number, |
| | Mobile Phone Number |
| Start Date | |
| Termination Date | |
| Parking Access Device Type | Keycard, Transponder, Permit, Hangtag |
| Parking Access Device | |
| Number | |
| Vehicle | Make, Model, Color, Year, License Plate |
| | Number, Vehicle Image |
| Alt. Vehicle | Make, Model, Color, Year, License Plate |
| | Number, Vehicle Image |
| User Code | Unique identifier assigned to user |

Only some of the data fields detailed in Table 5 may be required for a profile for a user; other fields may be optional. Further, in other embodiments, additional, fewer, or different data fields may be present within a profile for a user. The user profile created at step 1710 may be stored by the parking management system. At least some of the data fields of Table 5 may be specific to users; such fields may not be available in profiles for other types of entities (e.g. parking facilities, parking facility owners, etc.). When vehicle information is updated by a manager, a date and time of the update may be stored and available via the user profile.

At step 1710, a user may be permitted to select a parking space or type of parking space within a parking facility that the user desires to use or lease. In some embodiments, this occurs separately from the user creating a user profile.

At step 1720, a profile may be created for a group account. A group account may be for a group of users that have a group arrangement for parking. For example, a corporate parking account may be used to provide an employee of a company with parking paid for by the company, parking at a reduced rate, and/or access to parking spaces reserved for the corporate parking account. The corporate account may result in a set price, discount, or rate for all members of the group. Creating a profile for a group account may involve characteristics specific to the group account being provided by a parking manager. As such, step 1720 may involve a manager imputing data about the group parking account. Referring to FIG. 1, the manager may use parking facility management system 130 to provide information to parking management server 110. If a profile has previously been created for the group account, the creation of a new profile for the group account may not be necessary. Rather, the previously created profile may be used. Table 6 indicates data that may be provided by a manager or user regarding a group account. Additionally, data presented as part of table 7 may be provided by the manager or user.

TABLE 6

| Group | |
|---|---|
| Account Profile Fields | Details/Selection Options |
| Tenant (of a building) | Yes/No |
| Company Name | |
| Company Address | City, State, Zip Code, Suite No. |
| Contact Information | Phone Number, Fax Number, Website |
| Business Industry | |
| Square Footage Occupied | |
| Primary Account | |
| Administrator Name | |
| Contact Information for | Title, Address, Phone Number, Fax Number, |
| Primary Account | Email Address |
| Administrator Name | |
| Secondary Account | |
| Administrator Name | |
| Contact Information for | Title, Address, Phone Number, Fax Number, |
| Secondary Account | Email Address |
| Administrator Name | |
| Account Status | Active/Inactive |
| Rate Adjustment | Yes/No |
| Parking Lease Abstract | (Outlines information in lease such as |
| | number of spaces, types of spaces, and |
| | prices) |
| Monthly Lease Cost | |
| Lease Allocation | (Total Number and/or Number per type) |
| Group Account Code | Unique identifier assigned to group account |

Only some of the data fields detailed in Table 6 may be required for a profile for a group account; other fields may be optional. Further, in other embodiments, additional, fewer, or different data fields may be present within a profile for a group account. The group account profile created at step 1720 may be stored by the parking management system. At least some of the data fields of Table 5 may be specific to a group account; such fields may not be available in profiles for other types of entities (e.g. parking facilities, parking facility owners, users, etc.). At this point, the group account may be defined, but may not be linked with any particular parking facility.

The group parking account may provide a discount on the market rate for a parking facility. For example, if a profile for a parking facility lists the parking facility as having a market rate of a certain price, the group account may provide a percentage discount or a lower fixed price than the market rate price (e.g., for daily parkers) for the parking facility. A group account may further be associated with various rate tables. For instance, a first rate table may be valid for the group account for a first period of time, while a second rate table may be valid for a second period of time. This may be useful if the rates associated with the group account are slated to change over time. As an example of this, consider a lease signed by a company. The lease may state that for years 1-5 the price for parking under the group account is 50% of the market rate and in years 6-10 the price for parking is 85% of the market rate. By such information being included in the company's group account profile, the pricing may automatically be adjusted at the appropriate time and/or may allow for payment in relation to the group account to be forecast.

At step 1730, the profile for the group account created at step 1720 may be linked with the profiles for one or more parking facilities. When a group account profile is linked with a parking facility, this may enable users previously linked or that are linked in the future with the group account to use the linked parking facilities in accordance with the pricing of the group account. Costs incurred by a user at a parking facility linked with a group account with which the user is linked may be paid via the group account rather than by the user. Step 1730 may involve receiving input from a manager that indicates the profile of the group account is to be linked with the profile of a parking facility and storing an indication of the link between the profile of the group account and the one or more parking facilities. Linking the group account profile with the parking facility profile may involve selecting the profile of the parking facility from within the profile of the group account or selecting the profile of the group account from within the profile of the parking facility (e.g., via drop down menus).

In addition to the profile of a parking facility being linked with a group account, the group account may be linked with a tenant location. This link may serve to indicate where the offices (or residences) of the persons linked with the group account are located. As an example, company “ABC” may have a group account for its employees. This group account may be linked to a particular parking facility where members of the group account are permitted to park. The group account may also be linked to a profile of a tenant location that is where the offices of company ABC are located. The parking location and the tenant location may be the same location or a different location. For example, the tenant location may be a building in the vicinity of the parking location. One possible reason why having profiles of group accounts linked to profiles of tenant locations may be useful is so that if it is necessary for an alternate parking facility to be used for the members of a tenant location, the tenant location may be (temporarily) linked with a secondary parking facility in the vicinity of the tenant location. This may result in each group account linked with the tenant location becoming linked with the profile of the secondary parking facility, thus permitting parking access to each parker of the group accounts. Rather than having to link each group account with the secondary parking facility individually, a manager may only need to link the tenant location associated with the multiple group accounts to the secondary parking facility.

At step 1740, the profile for the group account created at step 1720 may be linked with the profile created for the user at step 1710. It should be understood that step 1740 may also be performed prior to step 1730. A group account profile may be linked with more than one user profile. As such, multiple, tens, or hundreds of user profiles may be linked with a particular group account profile. As such, when a group profile is linked with a parking facility, the rights of all (or some) of the users linked with the group profile may be permitted or eligible to use the parking facility. Step 1740 may involve receiving input from a group tenant, such as via group tenant computer system 280 of FIG. 2, that indicates the profile of the group account is to be linked with the profile for the user and storing an indication of the link between the profile of the group account and the user. The group tenant manager who links the user's profile with the group account profile may be a manager of the group tenant authorized to perform such actions in relation to the group account, such as an employee of the company that holds the group account. Linking the group account profile with the user profile may involve selecting the profile of the user from within the profile of the group account or selecting the profile of the group account from within the profile of the user (e.g., via drop down menus). Previously, such as detailed in relation to FIG. 4, the user may have indicated that the user is to be linked to the group account.

When a user account is linked with a group account, the user may continue to use the user account in conjunction with parking not associated with the group account. For example, if the user is linked with a group account held by an employer of the user, the group account may pay for a leased parking space for the user for during working hours. The user may be responsible for parking fees incurred against the user account not associated with the leased parking space, such as parking on the weekend or at other parking facilities. Some expenses related to parking may be divided between a group account and the user. For example, if a user selects a parking space of greater value than a lease allocation available to the user via the group account, a split obligation may be assigned between the user account and the group account. In such embodiments, the group account may pay a portion of the cost for the leased space, with the user paying the remainder.

At step 1750, a particular parking facility that is linked with the corporate account profile may be linked with the user profile. While the group account may be linked with multiple parking facilities, a user associated with the group account may only be permitted to use one (or a subset) of the parking facilities linked with the group account. As such, at step 1750, the user profile may be linked with one or more of the profiles of the parking facilities that have been previously linked with the group account. Beyond linking the user profile with a particular parking facility, if the parking facility has multiple types of parking (such as reserved, non-reserved, rooftop), the user profile may be linked to a specific type of parking. In other embodiments, if a user profile is linked with a group account profile, the user is permitted to use all of the parking facilities that are linked with the group account at either a discount rate associated with the group account or with payment for the parking being paid via the group account. If such a user parks at a parking facility not associated with the group account, the user may be responsible for payment via a person payment account associated with the user's profile. Accordingly, the same user profile may be linked with a group account profile which handles full or partial payment at certain parking facilities (possibly only at certain times or in certain types of parking spaces) while the user is directly charged for parking when parking at parking facilities not associated with the group account.

At step 1760, indications of the numbers and/or types of parking spaces associated with the group account at the parking facility may be provided by the parking management system. For example, Table 7 provides an exemplary display of the information that may be presented to the manager. This display of information may include primary and secondary rate table adjustments. Secondary rate table adjustments reflect the date the lease is adjusted to a different rate (e.g., market rate) and/or when a second tier of discounts take effect. For example, following the date of the primary rate table expiring for a group account, the data present for a secondary rate table may be applicable to a group account. Further, the information may include indications of the number of spaces allotted under the group account at the parking facility and the number of the parking spaces already assigned to other users of the group account.

Table 7, as presented below, includes additional examples of the types of data that may be stored and presented to a manager regarding group account. For example, data such as square footage occupied by a business associated with the group account, a lease ratio, a lease allocation (broken down for types of parking spaces), a rate code, a billing rate, a term expiration date, an abstract whether there is a rate adjustment, a date associated with the rate adjustment, etc. Other data fields are also possible. Data of table 7 may have been provided by a manager or may have been calculated based on other stored values (e.g., predetermine market rates for parking).

TABLE 7

| | | | |
|---|---|---|---|
| Facility ID: | 123 Main | | |
| | Street | | |
| Monthly Lease | Dec. 1, 2012 | | |
| Billing Date | | | |
| Square Footage | 3000 | Parking Space | 1 space per/ |
| Occupied: | | Ratio: | 600 sq. ft. |

Primary Rate Table

| | | | |
|---|---|---|---|
| Allocated Spaces | Reserved - 4 | Non-reserved - 1 | Total Spaces |
| | | | Allocated (5) |
| Complimentary | Reserved - 1 | Non-reserved - 0 | |
| Spaces | | | |
| Contract Rate | Reserved: $240 | Unreserved: $180 | |
| Monthly Lease | $1140 | Lease Termination | Aug. 31, 2012 |
| Billing | | Date | |

Secondary Rate Table

| | | | |
|---|---|---|---|
| Rate Adjustment? | Yes | Date: | Sep. 1, 2012 |
| Allocated Spaces | Reserved - 4 | Non-reserved - 1 | Total Spaces |
| | | | Allocated (5) |
| Complimentary | Reserved - 1 | Non-reserved - 0 | |
| Spaces | | | |
| Contract Rate | Reserved: $260 | Unreserved: $200 | |
| Monthly Lease | $1240 | Lease Termination | Aug. 31, 2013 |
| Billing | | Date | |

| | |
|---|---|
| Parking Lease | 5 total parking spaces, up to four of which are |
| Abstract: | permitted to be reserved parking spaces. Lease is for |
| | 2 years with price increase after first year, lessee can |
| | cancel parking for the unreserved parking space |
| | at any time. |

Only some of the data fields detailed in Table 7 may be required for a profile for a group account; other fields may be optional. Further, in other embodiments, additional, fewer, or different data fields may be present within a profile for a group account.

At step 1770, the profile of the user may be linked with a type of parking space at the parking facility, such as a reserved parking space, via the profile of the parking facility. The profile of the user may also be linked with a specific parking space within a parking facility. This may decrease the number of reserved parking spaces available to be allocated to other users linked with the group account. The user linked with the parking space at step 1770 may be permitted to access the parking facility and park in the parking space. Depending on factors such as cost, the group account may partially or fully pay for the user's parking space at the parking facility linked with the group account.

If a user is to be removed from a group parking account, the user account may be unlinked from the group parking account, but the user's profile and account may remain active and may still be used in conjunction with parking by the user. The user may only lose the benefits associated with the group parking account (e.g., payment of a lease of a parking space and/or a discounted rate at particular parking facilities), while the user profile otherwise remains active.

Additional types of profiles may also be created and used in conjunction with the parking management system. FIG. 18 illustrates an embodiment of a method 1800 for managing parking using tenant locations. For example, a tenant location may be an office building having multiple users or group accounts associated with the tenant location. A parking manager may want to assign or permit parking for all tenants of a building to one or more parking facilities. As an example of this, if a parking facility is connected with an office building, but the parking facility does not have sufficient parking spaces for all of the tenants, the parking manager may want to permit the tenants to use an additional parking facility nearby.

In method 1800, a profile for a tenant location (that is, a location which multiple users of a parking facility are associated with, such as an office building, condominium complex, or apartment building) is linked with a profile of a parking facility and/or a management entity. A tenant location may also be linked with profiles for one or more tenants. The tenant location may also be linked with a profile of at least one user (in some embodiments, this may be by way of the tenant location being linked to a tenant that is, in turn, linked to particular users). Method 1800 may be performed using a parking management system, such as parking management system 100 of FIG. 1 or parking management system 200 of FIG. 2. Some other form of parking management system may also be used to perform method 1800. A computerized device, such as a computer system, may be used to perform method 1800.

At step 1810, a profile for a tenant location, such as an office building, may be created. Creating a profile for a tenant location may involve characteristics specific to the tenant location being provided by a manager. As such, step 1810 may involve a manager imputing data about the tenant location. Referring to FIG. 1, the manager may use parking facility management system 130 to provide such information to parking management server 110. If a profile has previously been created for the tenant location, the creation of a new profile for the tenant may not be necessary. Rather, the previously created profile may be used. Table 8 indicates data that may be provided by a manager or user regarding the tenant location.

TABLE 8

| Tenant | |
|---|---|
| Location Profile Fields | Details/Selection Options |
| Building Name | |
| Address | |
| Building Classification | Class A/Class B/Class C |
| LEED Certification | Base/Silver Level/Gold Level/Platinum Level |
| Description of Building | |
| Rentable Square Footage | |
| Rentable Square Feet | |
| Building Amenities | Bank, ATM, Food, Coffee, Fitness Center, |
| | Cleaners, Basketball Court, Bocce Ball |
| | Court, etc. |
| Distance to | |
| Tenant Location Code | Unique identifier assigned to Tenant |
| | Location |

Only some of the data fields detailed in Table 8 may be required for a profile for a tenant location; other fields may be optional. Further, in other embodiments, additional, fewer, or different data fields may be present within a profile for a tenant location. The tenant location profile created at step 1810 may be stored by the parking management system. At least some of the data fields of Table 8 may be specific to tenant locations; such fields may not be available in profiles for other types of entities (e.g. parking facilities, parking facility owners, users, etc.). At this point, the tenant location may be defined, but may not be linked with any particular user or parking facility.

At step 1820, a profile for a management entity (e.g., a management company) may be created. A management entity may be an entity that provides management services, security services, and/or maintenance services for one or more locations. A management entity may be responsible for the operation and/or maintenance of a tenant location, such as an office building. This information may be used for contacting the management of the tenant location if a problem arises with a parking facility linked with the tenant location (e.g., alternative parking arrangements need to be made). Creating a profile for a management entity may involve characteristics specific to the management entity being provided by a manager. As such, step 1820 may involve a manager inputting data about the management entity. Referring to FIG. 1, the manager may use parking facility management system 130 to provide such information to parking management server 110. If a profile has previously been created for the management entity, the creation of a new profile for the management entity would not be necessary. Rather, the previously created profile may be used. Table 9 indicates data that may be provided by a manager or user regarding the management entity.

TABLE 9

| Management | |
|---|---|
| Entity Profile Fields | Details |
| Name (e.g., Company | |
| Name) | |
| Address | Street, City, State, Zip Code |
| Phone | |
| Property Manager | Title, Department, Mobile Phone Number, |
| | Office Phone Number, Email Address |
| Management Entity Code | Unique identifier assigned to management |
| | entity |
| Emergency Contact | Name, address, phone number, email address, |
| | title, location |

Only some of the data fields detailed in Table 9 may be required for a profile for a management entity; other fields may be optional. Further, in other embodiments, additional, fewer, or different data fields may be present within a profile for a management entity. The management entity profile created at step 1810 may be stored by the parking management system. At least some of the data fields of Table 9 may be specific to the management entity; such fields may not be available in profiles for other types of entities (e.g. parking facilities, parking facility owners, users, etc.). At this point, the management entity may be defined, but may not be linked with any particular tenant location.

At step 1830, the management entity profile may be linked with the tenant location profile. This link may be based on an indication input by a manager and the link may be saved by the parking management system. The link may indicate that the parking management entity manages the tenant location. If the management entity managing the location changes, a different management entity may be linked with the tenant location. Linking the management entity profile with the tenant location profile may involve selecting the profile of the management entity from within the profile of the tenant location or selecting the profile of the tenant location from within the profile of the management entity (e.g., via drop down menus).

Additionally, the management entity profile may be directly linked to one or more profiles of parking facilities. As such, a management entity may be linked with one or more parking facility profiles and/or one or more tenant location profiles. A link between a parking facility profile and a management entity profile may indicate the management entity is responsible for management of the parking facility and/or that the parking facility is at a location managed by the management entity. Sublinks may also be used to refine the definition of the management entity. For example, a national company may be used as the management entity, while a regional office of the national company may be sublinked as the office responsible for particular parking facilities and/or tenant locations.

At step 1840, one or more user profiles and/or group accounts may be linked with a tenant location profile. This may serve as an indication that each user identified by the linked user profile and/or the group accounts are associated with the tenant location. For example, this may indicate that the users work or live in the tenant location (e.g., office or apartment building). If one or more user profiles or group accounts need to be created, profiles may be created similar to in steps 1710 and 1720 of method 1700. Additionally or alternatively, profiles of tenants of the tenant location may be linked with the tenant location profile. Such tenants may be businesses or other entities that lease or own space within the tenant location. In some embodiments, rather than user profiles being linked directly with the tenant location, the user profiles may be linked with tenants, which may be linked with the tenant location.

At step 1850, the profile of the tenant location may be linked to a profile of a parking facility. A profile for the parking facility may have already been created (such as detailed in step 1610 of FIG. 16). When a tenant location profile is linked with a parking facility profile, this may enable users linked with the tenant location profile to use the linked parking facilities. Step 1850 may involve receiving input from a manager that indicates the profile of the tenant location is to be linked with the profile for a parking facility and storing an indication of the link between the profile of the tenant location and the one or more parking facilities. Linking the parking facility profile with the tenant location profile may involve selecting the profile of the parking facility from within the profile of the tenant location or selecting the profile of the tenant location from within the profile of the parking facility (e.g., via drop down menus). Method 1800 assumes that a profile for the parking facility has already been created. If not, a profile for the parking facility may be created similarly to step 1610 of FIG. 16.

At step 1860, parking rates (cost per month, cost per hour, cost per day, etc.) may be set by the manager for the users of the tenant location for the parking facility. As such, the users of the tenant location may receive different rates than other users associated with the parking facility. By default, the parking rates may be the market rates available to the public. Separate rates may be present for tenants and non-tenants, reserved parking spaces and/or non-reserved parking spaces. Volume information may indicate the number of spaces each tenant (e.g., corporate occupant of the tenant location) and/or group account is allocated for the parking facility. This may be a number selected by the parking manager or may be calculated based on the square footage of the tenant location leased by the tenant. As such, only a certain number of users linked with a tenant may be permitted access to the parking facility. Such rate and volume information may be stored at step 1870 by the parking management system.

At step 1880, access to the parking facility (at the rate and volume input by the parking manager) may be permitted for users associated with the tenants of the tenant location and/or users of the tenant locations linked with the particular parking facility.

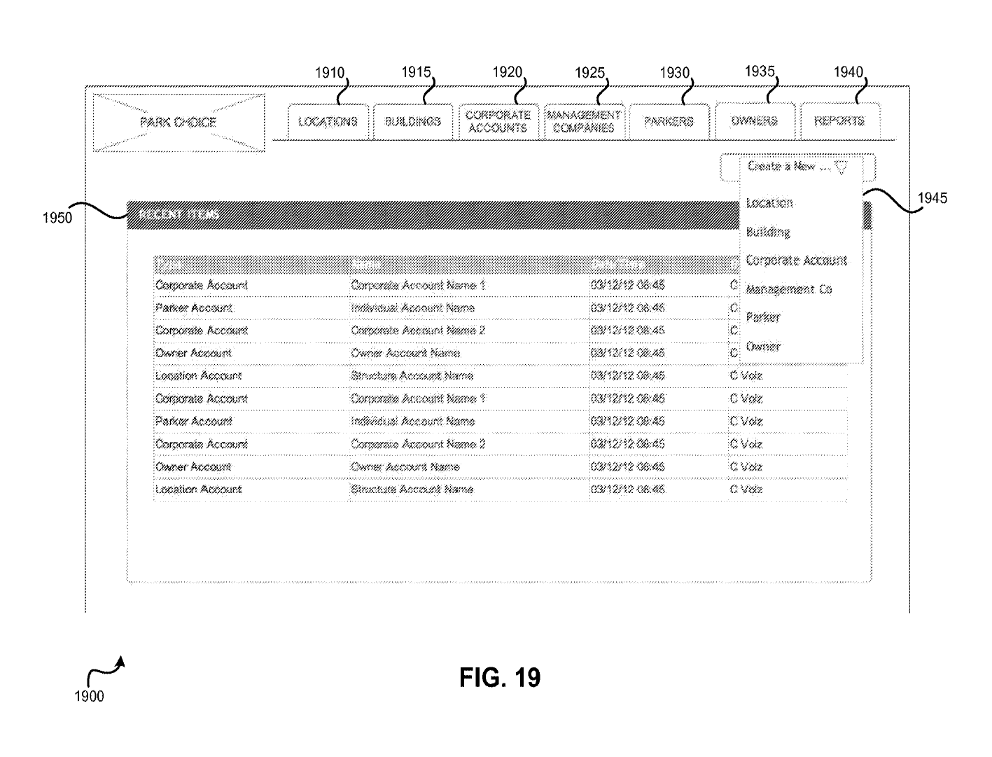

FIG. 19 illustrates an embodiment of a graphical user interface 1900 for interacting with profiles. Graphical user interface 1900 may be provided to a parking manager upon logging into a parking management server, such as parking management server 110 of FIG. 1. Graphical user interface 1900 may permit the manager to create, edit, and manage profiles, including linking various profiles. Access may be provided to the various profiles previously created: locations 1910 (e.g., parking facilities); buildings 1915 (e.g., tenant locations); corporate accounts 1920 (e.g., group accounts); management companies 1925 (e.g., management entities); parkers 1930 (e.g., users); owners 1935 (e.g., parking facility owners); and reports 1940 (e.g., reports generated about specific parking facilities and/or reports generated for owners about multiple parking facilities.

An interface 1945 may be provided for creating a new profile. Interface 1945 may permit the manager to select from among multiple types of profiles. The data items that are required and/or are optional within each profile may vary based on the profile type. Further, the links permitted with other profiles may be at least partially based on the type of profile. For example, a link may be permitted between a profile for an owner and a profile of a parking facility, but not between two profiles of owners.

Recent items 1950 may provide a parking manager with a listing of a number of profiles (referred to here as accounts) that were previously accessed. Recent items 1950 may provide the manager with access to the profiles most recently interacted with. These profiles may be profiles the manager most recently accessed. The layout and specific items presented in graphical user interface 1900 is not intended to be limiting; other embodiments may have more, fewer, or different components. Further, the layout of graphical user interface 1900 may be varied in other embodiments.

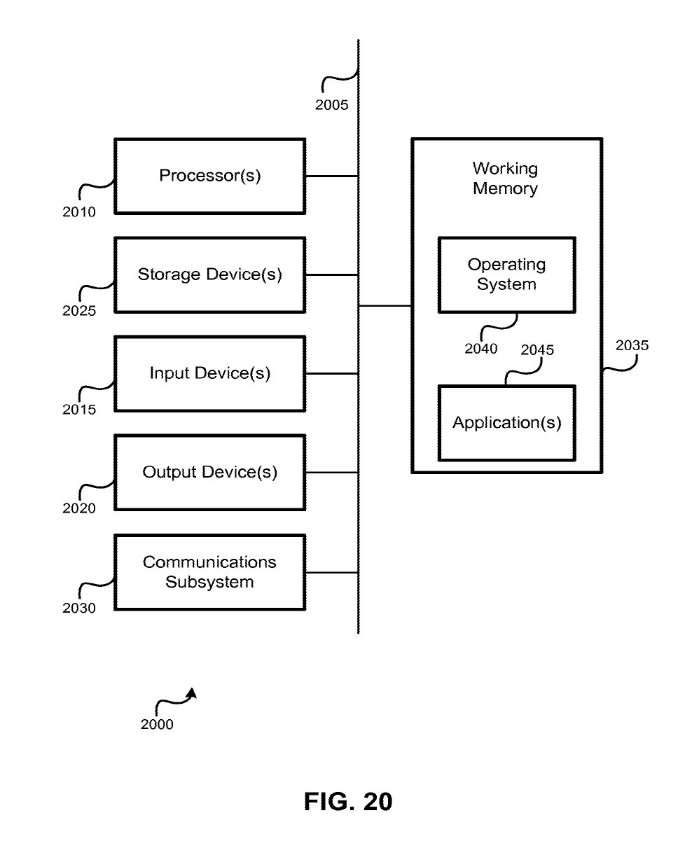

FIG. 20 illustrates an embodiment of a computer system. A computer system as illustrated in FIG. 20 may be incorporated as part of the previously described computerized devices. For example, computer system 2000 can represent some of the components of the mobile devices and/or the remote computer systems discussed in this application. FIG. 20 provides a schematic illustration of one embodiment of a computer system 2000 that can perform the methods provided by various other embodiments, as described herein, and/or can function as the parking management server, parking facility management computer system, mobile device, remote computer system, tenant computer system, and/or the computer system of the parking facility access systems. It should be noted that FIG. 20 is meant only to provide a generalized illustration of various components, any or all of which may be utilized as appropriate. FIG. 20, therefore, broadly illustrates how individual system elements may be implemented in a relatively separated or relatively more integrated manner.

The computer system 2000 is shown comprising hardware elements that can be electrically coupled via a bus 2005 (or may otherwise be in communication, as appropriate). The hardware elements may include one or more processors 2010, including without limitation one or more general-purpose processors and/or one or more special-purpose processors (such as digital signal processing chips, graphics acceleration processors, and/or the like); one or more input devices 2015, which can include without limitation a mouse, a keyboard, and/or the like; and one or more output devices 2020, which can include without limitation a display device, a printer, and/or the like.

The computer system 2000 may further include (and/or be in communication with) one or more non-transitory storage devices 2025, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 2000 might also include a communications subsystem 2030, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 2030 may permit data to be exchanged with a network (such as the network described below, to name one example), other computer systems, and/or any other devices described herein. In many embodiments, the computer system 2000 will further comprise a working memory 2035, which can include a RAM or ROM device, as described above.

The computer system 2000 also can comprise software elements, shown as being currently located within the working memory 2035, including an operating system 2040, device drivers, executable libraries, and/or other code, such as one or more application programs 2045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 2025 described above. In some cases, the storage medium might be incorporated within a computer system, such as the computer system 2000. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 2000 and/or might take the form of source and/or installable code, which, upon compilation and/or installation on the computer system 2000 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 2000) to perform methods in accordance with various embodiments of the invention. According to a set of embodiments, some or all of the procedures of such methods are performed by the computer system 2000 in response to processor 2010 executing one or more sequences of one or more instructions (which might be incorporated into the operating system 2040 and/or other code, such as an application program 2045) contained in the working memory 2035. Such instructions may be read into the working memory 2035 from another computer-readable medium, such as one or more of the storage device(s) 2025. Merely by way of example, execution of the sequences of instructions contained in the working memory 2035 might cause the processor(s) 2010 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 2000, various computer-readable media might be involved in providing instructions/code to processor(s) 2010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 2025. Volatile media include, without limitation, dynamic memory, such as the working memory 2035.

Common forms of physical and/or tangible computer-readable media are non-transitory and include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 2010 for execution. Merely by way of example, the instructions may initially be carried on a magnetic disk and/or optical disc of a remote computer. A remote computer might load the instructions into its dynamic memory and send the instructions over a transmission medium to be received and/or executed by the computer system 2000.

The communications subsystem 2030 (and/or components thereof) generally will receive the signals, and the bus 2005 then might carry the signals (and/or the data, instructions, etc. carried by the signals) to the working memory 2035, from which the processor(s) 2005 retrieves and executes the instructions. The instructions received by the working memory 2035 may optionally be stored on a storage device 2025 either before or after execution by the processor(s) 2010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

1. A method for managing one or more parking facilities, the method comprising:
creating, by a computer system, a first profile for a parking facility that defines characteristics of the parking facility, the characteristics of the parking facility comprising:
an address of the parking facility,
a number of parking spaces of the parking facility, and
a type of the parking facility;
creating, by the computer system, a second profile for an owner of the parking facility that defines characteristics of the owner, the characteristics of the owner comprising:
a name of the owner, and
an address for the owner;
receiving, by the computer system, input that indicates to link the owner to the parking facility using the first profile and the second profile; and
linking, by the computer system, the owner to the parking facility using the first profile and the second profile, wherein the second profile is available to be linked with profiles of additional parking facilities.
